(19) United States
(12) Patent Application Publication
(10) Pub. No.: US 2025/0345733 A1
(43) Pub. Date: Nov. 13, 2025

(54) ADAPTER ELEMENT, FILTER CARTRIDGE, AIR FILTER DEVICE AND METHOD FOR REPLACING FILTER CARTRIDGE

(71) Applicant: MANN+HUMMEL Life Sciences & Environment Holding Singapore Pte. Ltd., Singapore (SG)

(72) Inventors: Karlheinz MÜNKEL, Oberderdingen-Flehingen (DE); Ulrich DEHNEN, Kornwestheim (DE); Joseph POWER, Fellbach (DE)

(21) Appl. No.: 19/276,141

(22) Filed: Jul. 22, 2025

Related U.S. Application Data
(63) Continuation of application No. PCT/IB2024/050475, filed on Jan. 18, 2024.

(30) Foreign Application Priority Data
Jan. 27, 2023 (WO) PCT/EP2023/051981

(51) Int. Cl. B01D 46/00; B01D 46/24; B01D 46/58

(52) U.S. Cl. CPC B01D 46/0008; B01D 46/2414; B01D 46/58; B01D 2265/022; B01D 2265/028; B01D 2271/022; B01D 2271/027

(57) ABSTRACT

Air filter device including a base plate with a plurality of spaced-apart flow openings and a plurality of filter cartridges each having at least one gas filter medium, the base plate includes adjacent to the flow openings at least one mounting device for mounting one filter cartridge each on the base plate, the filter cartridges each having at least one counter mounting means corresponding to the mounting device that is brought into operative connection with the respective mounting device of the base plate. The mounting device being a snap connection and the corresponding counter mounting means being a counter snap connection, the snap connection and the counter snap connection forming a snap connection, and the counter snap connection brought into operative connection with the snap connection by an axial movement. An air filter cartridge and an adapter for the air filter device. A method for replacing the air filter cartridge.

### CROSS-REFERENCE TO RELATED APPLICATIONS

This application is a continuation application of international application No. PCT/IB2024/050475 having an international filing date of Jan. 18, 2024, and designating the United States, the international application claiming a priority date of Jan. 27, 2023, based on international application No. PCT/EP2023/051981, the entire contents of the aforesaid international applications being incorporated herein by reference.

### TECHNICAL FIELD

The present invention relates to an adapter element, a filter cartridge for an air filter device, an air filter device and a method for replacing a filter cartridge of an air filter device.

### BACKGROUND

Exemplary filter cartridges matching the above description are disclosed for example in printed document “CAMCARB CG MOLECULAR FILTER” of camfil, cf https://www.camfil.com/product/documents/dam/25501/Brochures-CamCarb-CG.pdf.

These filter cartridges including adsorber material may be used for particle filtration, such as air particle filtration, or as a gas phase air filter installed in supply, recirculation, and exhaust air systems in commercial, industrial, and process applications, such as airports. Areas of applications are for example adsorption of odours, toxic gaseous pollutants, hydrocarbons and solvents.

A plurality, for example 4, 8, 12, 16 or hundreds, of filter cartridges are mounted onto a dedicated base plate or mounting frame designed to fit easily into a standard filter housing. For mounting the filter cartridges on the base plate, integrated bayonet fastenings are used, for example the filter cartridges are fitted in a bayonet-type socket. Between the bayonet socket and the mounting frame, an axial sealing is compressed during fastening the bayonet.

In detail, each filter cartridge includes a standard interface bayonet connection with three mushroom-like connecting elements. On the side of the base plate, corresponding counter elements, the bayonet slots, are arranged.

The filter cartridges need to be replaced or exchanged at regular intervals. Assembling the individual cartridges requires manually joining the three bayonet pins into the bayonet holes and then applying torque to rotate them by a defined rotation angle, for example about 15 degrees, into the final position. As the interaction of the bayonet pins and holes is arranged at the side of the filter cartridge facing away from the user during the assembling process, this assembling procedure is time-consuming and error prone. It may happen that not all bayonet pins are in the correct position, which leads to leakage and malfunction of the filter cartridge and/or the air filter device. This is especially problematic, because the user gets no clear feedback whether the bayonet pins are correctly inserted into the holes or whether the final position is reached during the rotation process. Even if the bayonet is correctly installed, the air filter device may leak over time, because due to gravity and the weight of the filter cartridge, the axial sealing is compressed at the bottom side of the filter cartridge creating a narrow gap on the top side.

### SUMMARY

In view of the disadvantages and shortcomings described above, an object of the present invention is to further develop an adapter element, a filter cartridge, an air filter device and a method for replacing a filter cartridge of an air filter device, such that assembly of the filter cartridge to the base plate is simplified and efficiency of assembly is increased. For replacing or exchanging the filter cartridge, i.e. for dissembling a used-up filter cartridge from the base plate and assembling a fresh filter cartridge to the base plate, there is no need for precise insertion of counter mounting means into mounting means and twisting/rotating the filter cartridge as with the bayonet lock.

The objects of the present invention are achieved by an air filter device, by a filter cartridge, by an adapter element as well as by a method as disclosed herein. Embodiments and expedient improvements of the present invention are disclosed in the following description and the accompanying drawing figures.

The present invention is principally based on the idea to provide a novel interface, namely a snap connection, for directly or indirectly assembling the filter cartridge to a base plate with a plurality of spaced-apart flow openings. One advantage of the snap connection is, that during assembly, a clear snapping feedback is given when the final connection position is reached. This feedback of the snap connection may be noticed by the user of the air filter device haptically and/or acoustically. Thus, for assembly, the user may simply push the filter cartridge into the snap connection until it clicks.

The present invention is further based on the idea to design the snap connection for being moved from its connected or locked position to its unconnected or unlocked position and vice versa by means of an axial movement. In this context, axial movement is defined as a movement along the longitudinal axis of the filter cartridge plus or minus a deviation of about 10 degrees from the longitudinal axis, for example plus or minus a deviation of about 5 degrees from the longitudinal axis. Thus, for bringing the counter mounting means, in this case counter snap connection means, of the filter cartridge into operative connection with the snap connection means of the base plate, a rotational movement is specifically not required. In other words, for assembly and disassembly no turning movement or rotational mounting of the filter cartridge is required. This axial locking and unlocking mechanism simplifies assembly of the filter cartridge to the base plate and increases efficiency thereof.

In this context, axial refers to a direction along the longitudinal axis of the filter cartridge and radial refers to a direction perpendicular to the longitudinal axis of the filter cartridge.

The snap connection may include at least one, for example at least two diagonally arranged, snap connection means and at least one counter snap connection means. The snap connection may alternatively include a snap connection means and a counter mounting means that abut each other to form an operative connection by friction. The snap connection means may be arranged to the base plate or to an adapter element of the base plate providing an interface to the filter cartridge. The counter snap connection means may be arranged to the filter cartridge providing an interface to the base plate. An inverted design is also possible.

According to an embodiment of the present invention, the counter snap connection means is arranged at a connection interface of an open end cap of the respective filter cartridge. To allow the filter cartridge to be mounted at any angle of rotation to the adapter element, the connection interface may be formed circular.

Independently thereof or in connection therewith, according to an embodiment of the present invention, the outer diameter of a radial peripheral edge of the adapter element facing to the base plate and including a further counter mounting means may be circular. This leads to the advantage that the adapter element may be mounted at any angle of rotation relative to the base plate.

The connection interface has a smaller diameter than the filter medium body including the gas filter medium. This leads to the benefit, that the snap connection means of the base plate or of an adapter element of the base plate may be arranged on a circular snap connection collar having the same outer diameter or at most the same outer diameter as the open end cap. Thus, filter cartridges may be placed on the base plate next to each other in a small space.

The connection interface may include ribs 54 designed for reinforcing the retention force of the connection interface.

The snap connection means may be designed as at least one radially deformable, or radially elastic, or radially acting or radially resilient snap-on means, such as an engagement hook or snap arm, or snap nose or snap fit. The counter mounting means may be designed as at least one engagement groove being engageable with the snap-on means. To enable assembling the filter cartridge to the base plate independently of the rotation angle of the filter cartridge, the engagement groove is formed circumferentially and/or open radially outward. This embodiment enables position-independent connection of the filter cartridge with the base plate.

The snap connection means may be designed as a radially deformable, or radially elastic, or radially acting or radially resilient material formed circumferentially to snugly fit the counter mounting means with corresponding dimensions, so that the connection occurs by friction. The snug-fit of such connection enables the user to simply fit the filter cartridge onto the base plate or the adapter element. Assembly of the filter cartridge onto the base plate or the adapter element from an unconnected or unlocked position to a connected or locked position and vice versa may be done by means of an axial movement, with slight rotational adjustments to overcome the frictional forces.

By changing e.g. the angles and/or radius at both snap-fit partners, i.e. the snap-on means and the counter mounting means, the clamping-, mounting-, demounting force may be influenced. Moreover, the clamping-, mounting-, demounting force may be influenced by varying the numbers of snap-fit partners.

To aid in demounting the filter cartridge, a face of the base plate or, if present a face of the adapter element, facing the filter cartridge may include at least one ramp that urges the filter cartridge away from the respective face and/or partially out of the snap connection means. The filter cartridge or its connection interface may include a corresponding ramp partner that engages with each ramp. The form of the ramp partner may be dependent on how much reduction of the demounting force is required. If a larger reduction in demounting force is required, the ramp partner may be in the form of a second ramp. When the filter cartridge is mounted on the base plate or adapter element, the filter cartridge is in the connected or locked position when the ramp and the second ramp do not engage each other. If a lower reduction in demounting force is required, the ramp partner may be in the form of a groove to house the ramp. The aforementioned axial movement to connect and disconnect the filter cartridge via the snap connection still applies. The filter cartridge remains mounted via the snap connection even if the ramp does not engage or partially engages the ramp partner. The mounted filter cartridge may simply be rotated so that the snap connection means and the counter snap connection means are fully engaged. To move the filter cartridge to its unconnected or unlocked position, the filter cartridge is rotated, thereby urging the filter cartridge along a sloping surface of the ramp and the corresponding sloping surface of the ramp partner, such that the filter cartridge is urged away from the face and/or partially out of the snap connection means. As the filter cartridge is urged axially away from the face, the ramp is termed an “axial ramp”. There may be one or more than one axial ramp, such as two, three or four axial ramps, and a corresponding number of ramp partners. An inverted design is also possible, where the axial ramp is on the connection interface of the filter cartridge and the ramp partner is on the face of the base plate or, if present a face of the adapter element.

In another embodiment, to aid in demounting the filter cartridge, a radial face of the filter cartridge where the counter snap connection means is arranged may include at least one ramp that urges the snap connection means of the base plate or, if present the adapter element, outwards and/or partially out of the counter snap connection means. As the snap connection means is urged radially outwards from the counter snap connection means due to the ramp, the ramp is termed a “radial ramp”. There may be one or more than one radial ramp, such as two, three or four radial ramps. For example, a radial ramp is provided to engage each snap connection means, e.g., a radial ramp engages each snap arm. When the filter cartridge is mounted on the base plate or adapter element, with the snap connection means engaging the counter snap connection means, or in other words not engaging the radial ramp, the filter cartridge is in the connected or locked position. The filter cartridge remains mounted via the snap connection even if the snap connection means engages the radial ramp. The mounted filter cartridge may simply be rotated so that the radial ramp is not engaged and the snap connection means and the counter snap connection means are fully engaged. To move the filter cartridge to its unconnected or unlocked position, the filter cartridge is rotated, thereby urging the snap connection means up a sloping surface of the radial ramp, such that the snap connection means is urged outwards and/or partially out of the counter snap connection means. The demounting force may therefore be minimal and the filter cartridge may be easily pulled out axially. In some embodiments, the radial ramp may include a stop rib at the top of the sloping surface of the radial ramp. The stop rib of the radial ramp may indicate, haptically and/or acoustically, that the snap connection means is at the position of lowest demounting force.

The snap connection means may be made for example of plastic or of sheet metal.

Where a counter bayonet fastening means is present, in order to prevent the bayonet connection from being operated in the loosening direction, the adapter element may include at least one locking means being designed to cooperate with the bayonet connection, for example to engage with the bayonet slot, in such way that in the locked position of the bayonet connection, the locking means prevents accidental loosening of the adapter element when the filter cartridge is installed or replaced. In other words, the locking means may provide a loosening lock to prevent unintentional loosening of the bayonet connection.

According to an embodiment of the present invention,
the filter cartridge or an adapter element of the base plate includes at least one further counter mounting means being designed as a counter bayonet fastening means for fastening the filter cartridge or the adapter element with the base plate by means of a bayonet connection and
the filter cartridge or the adapter element includes, adjacent to the counter bayonet fastening means, at least one locking means being designed for cooperating with a bayonet fastening means of the base plate, for example to engage with a bayonet slot, to prevent the bayonet connection from being accidentally loosened or rotated back.

The locking means is for example deformable in axial direction. For example, the locking means may be a nose formed like a triangular wedge with at least one bevel, wherein the nose deforms during assembly of the bayonet connection and deflects into the bayonet slot or engages in the recess of the bayonet when the bayonet is in its closed position. In this embodiment the locking means is designed as a safety catch to prevent accidental loosening of the adapter element from the base plate when the filter cartridge is removed or replaced.

According to an embodiment of the present invention, the open end cap includes a lower wall thickness around the locking means or adjacent to the locking means. Due to this reduced wall thickness, the wall around the locking means is deformable and allows the locking means to move a little bit in the direction of the longitudinal axis of the filter element when the locking means is pressed against the base plate during assembly of the bayonet connection.

Independently thereof or in connection therewith, the wall of the adapter element may be reduced adjacent to, for example at the back of, at least one of the snap connection means, so that it is easier to deform.

Basically, there are two exemplary embodiments of the present invention: the snap connection means may be assigned either directly to the base plate or be assigned to the adapter element.

If the snap connection means is directly assigned to the base plate, it is formed integrally with the base plate, or undetachably or inseparably connected with the base plate. Thus, it comes into operation without an adapter element.

The adapter element according to the present invention allows indirect connection of the filter cartridge to the base plate. In more detail, the adapter element allows a connection of the filter cartridge according to the present invention or of one the filter cartridges of the air filter device of the present invention to the base plate of the air filter device according to the present invention.

For allowing the connection to the filter cartridge, the adapter element includes the snap connection means. For allowing the connection to the base plate, the adapter element includes at least one further counter mounting means for example a counter bayonet fastening means, such as an engagement recess, for example a longitudinal slit at the end of which a short transverse slit is attached at a right angle. In a counter version, the counter bayonet fastening means includes at least one locking protrusion, e.g. at least one pin, which may be inserted into the engagement recess of a bayonet fastening element and then arranged in a closed position by means of a plug-in rotary movement. For allowing the adapter element to be connected to the base plate, other alternatives are conceivable, including riveting, welding or screwing the adapter element to the base plate.

According to an embodiment of the present invention, the bayonet connection of the adapter element has in each case at least two bayonet connection means, for example including in each case at least two locking projections on the adapter element and at least two corresponding engagement recesses on the base plate. The locking projections may be mushroom shaped, including at least one shaft, such as at least one tubular or cone-shaped shaft, and at least one hat, such as at least one flat or globular or cone-shaped hat. In embodiments, the shaft may exhibit an oval cross section.

Thus, the adapter element is on one hand assigned to the novel interface and on the other hand it may be assigned to a conventional bayonet interface. In more detail, the adapter element includes the snap connection means and may be connected itself with the base plate by means of a bayonet connection. According to this embodiment, each filter cartridge is indirectly mounted on the base plate via a respective adapter element by means of a bayonet connection. For example, the bayonet fastening means is arranged at the adapter element adjacent to the flow openings.

According to an embodiment of the present invention, the filter cartridges each include a closed end cap or upper end plate at one axial end facing away from the base plate and an open-end cap or lower end plate at the other axial end, wherein the end caps border the filter medium body terminally. The counter mounting means is arranged at the open-end cap, for example on a circumferential edge of the open-end cap. To provide an inflow of gas to be filtered into the filter cartridge, the open-end cap includes at least one inlet-opening being designed to be arranged in accordance with at least one of the flow openings of the base plate. For providing a compact and simple design of the filter cartridge, the adapter element may be assigned to the open-end cap.

The adapter element is designed as a lifetime component. This means, it normally remains at the base plate for the whole life of the air filter device even when the filter cartridge is replaced or exchanged. Consequently, there is no need for precise insertion of counter bayonet means into bayonet means and twisting the filter cartridge as with the bayonet lock for replacing or exchanging the filter cartridge at the base plate.

The filter cartridge is for example radially sealed with respect to the base plate, for example via at least one radial sealing means. This leads to the advantage, that even if the filter cartridge with time tilts a little obliquely creating a narrow gap on the top side, the radial sealing means reliably seals the filter cartridge with regard to the base plate.

The radial sealing means may be assigned directly to the base plate or to the adapter element or to the filter cartridge. For example, the radial sealing means is carried by a tubular socket section assigned to the base plate or by a snap connection collar, such as a tubular socket section including the snap connection means, assigned to the adapter element.

The radial sealing means is designed for being arranged between a radial peripheral edge of the open-end cap of the filter cartridge and a radial peripheral edge, such as a tubular nozzle segment, of the base plate or of the adapter element.

According to an embodiment of the present invention, the radial sealing means is designed for cooperating with the bayonet fastening means, for example to engage with the bayonet slot, to prevent the bayonet connection to be accidentally loosened or rotated back.

Independently thereof or in connection therewith, the filter cartridge or the adapter element may be axially sealed with respect to the base plate, for example via at least one axial sealing means or at least one injected adhesive element. With the axial seal, the adapter element is sealed against the base plate, for example against a sheet metal part of the base plate. This axial sealing means aids to avoid leaking of the air filter device due to lowering of the end of the filter cartridge not connected with the base plate caused by weight and gravity. The axial sealing means or adhesive may for example be arranged between the adapter element and the edge of the base plate surrounding one of the flow openings. The axial seal may be made from an elastomer, for example by means of two component injection molding technology.

According to an embodiment of the invention, in addition to the radial sealing element or inner sealing element, which goes against the collar of the filter cartridge, the air filter device includes a thin axial profile sealing means or injected adhesive for sealing the adapter element against the base plate and/or to prevent theoretical leakage through the bayonet connection. As stated before, alternatively to an axial sealing means the adapter element may be sealed by adhesive. Adhesive then also provides anti-reverse protection, which means that the bayonet connection cannot be accidentally loosened when the filter cartridge is mounted or demounted.

Each filter cartridge is formed hollow cylindrically and designed to be flowed-through radially by a gas stream to be filtered.

For being connected with the filter cartridge, the adapter element includes at least one axially extending snap connection collar being at least partly circumferential. Snap connection means are present on the snap connection collar. To provide a reliable snap connection, for example several snap connection means are symmetrically distributed over the circumference of the snap connection collar.

To provide a more bendable environment that is configured to bend inward when twisted and then snap back out into the bayonet slot or bayonet opening, the snap connection collar of the adapter element may be flattened or thinner-walled at least on one circumferential position.

According to an embodiment of the present invention, the snap connection collar of the adapter element is flattened on several, such as on four, circumferential positions, arranged in a diagonal arrangement. This leads to the advantage that several adapter elements may be mounted side by side in tight space.

The adapter element may include at least two, for example four, snap connection means, such as clips, and ribs designed for reinforcing the retention force for mounting the filter cartridge to the base plate.

For providing a compact arrangement, the snap connection means are for example diagonally arranged.

For providing elasticity of the snap connection collar of the adapter element, adjacent to the snap connection means, one or more flattened sections with reduced wall thickness may be arranged at the adapter element. As there is a fixed hole spacing of the bayonet connection, the flattened sections enable to install a defined maximum diameter of the adapter element. At the same time the flattened section protects the bayonet connection from being mounted incorrectly, because only if the flattened section is arranged correctly, the adapter elements are able to be mounted next to each other or on top of each other. With the flattened sections, for example four adapter elements fit on one base plate, such as a sheet metal base support.

A further advantage of this flattened section or thinner-walled circumferential position of the adapter element is that the flattened section allows the snap connection means, such as clips or snap-in hooks, to apply more force. During assembly, not only the snap connection means are deformed, but also the flattened section or thinner-walled circumferential position, and thus the entire circumference of the adapter element is expanded over the counter snap connection means, such as over ribs. Consequently, the adapter element may bear greater forces than if only held by snap connection means.

Reinforcement of the snap connection means may be achieved for example by ribs arranged at a collar of the open end cap of the filter cartridge or at the snap connection collar of the adapter element. Moreover, reinforcement of the snap connection means may be achieved by shorter snap-fits or circumferentially wider snap-fits. Ribs are advantageous, because they ensure that not only the snap-fit hook but also the ribbed connection of the snap-fit hook participates in the holding force. Thus, according to an embodiment of the invention, ribs or particularly high ribs are arranged in the area of the snap connection means and the wall thickness is reduced in the area adjacent to the snap connection means.

The flow openings of the base plate are for example arranged in a symmetric or regular pattern, such as rectangular-grid like. Moreover, the bayonet fastening elements are for example arranged in a symmetric or regular pattern to be able to arrange the filter cartridges next to each other. This arrangement of the flow openings as well as of the bayonet fastening elements together with the diagonal arrangement of the thinner-walled circumferential position of the adapter element allows to use the space of the base plate optimally and to arrange as many filter cartridges as possible with maximum diameter one above the other and next to each other.

For applying tensile or compressive force on the filter cartridge for the axial movement, the closed end cap may include at least one handle. Alternatively, at least one handle could be integrated in the closed end cap or upper end plate, which points away from the base plate.

The adapter element may consist of plastic leading to the advantage that it may be very cost-effectively manufactured. To provide high durability and stability, the adapter element may also consist of metal, for example of sheet metal.

The radial peripheral edge of the open end cap of the filter cartridge may include a raised rim extending therefrom. The raised rim may be arranged at a position on the open end cap to fit the flow opening on the adapter element or on the base plate. The raised rim provides a centering function. The raised rim helps to easily locate the correct position of the filter cartridge on the adapter element or base plate. Where the radial sealing means is assigned to the filter cartridge, the radial sealing means may be positioned between the raised rim and the radial peripheral edge of the open end cap. Alternatively, the raised rim may be assigned to the base plate or the adapter element on the side facing the filter cartridge. A raised rim may be provided around the circumference of each flow opening of the base plate or adapter element. In this embodiment, the filter cartridge may include a corresponding depression in the opening of the open end cap to fit the raised rim.

According to the present invention, the filter medium body of the filter cartridge includes at least one gas filter medium or particle filter medium. The gas filter medium may include at least one adsorbent, for example at least one activated carbon and/or zeolite and/or molecular sieve. The adsorbent gas filter medium may be designed as a bulk. In this embodiment the filter medium body provides a pouring chamber, which is delimited by an outer shell wall and an inner shell wall and into which an adsorbent bulk in granular particle form is filled. Alternatively, the gas filter medium may be for example a wound filter medium.

The present invention principally relates to loose-fill applications, such as beds, cartridges and modules, in molecular filtration. The present invention in more detail relates to the use of an adapter element as described above for connecting a filter cartridge, for example for a particle filter cartridge or for a gas phase air filter cartridge, as described above, to a base plate. Moreover, the present invention relates to the use of the filter cartridge as described above in an air filter device as described above. In general, the invented air filter cartridge may be used in supply, recirculation, and exhaust air systems in commercial, industrial, and process applications, such as airports. Areas of applications are for example adsorption of odors, toxic gaseous pollutants, hydrocarbons and solvents.

The present invention finally relates to the use of at least one adapter element as described above for replacing or exchanging an air filter cartridge according to the invention into an air filter device as described above.

### BRIEF DESCRIPTION OF DRAWINGS

As already discussed above, there are several options to embody as well as to improve the teaching of the present invention in an advantageous manner. To this aim, reference is made to the further improvements, features and advantages of the present invention described below in more detail with reference to exemplary embodiments by way of example and to the accompanying drawing figures where:

FIG. 1 shows in longitudinal section a first embodiment of an air filter device according to the present invention comprising a first embodiment of an adapter element according to the present invention, as well as a first embodiment of a filter cartridge of the present invention, which filter cartridge may be replaced according to a method of the present invention;

FIG. 2 shows a perspective view of the air filter device of FIG. 1 from diagonally in front;

FIG. 3 shows a perspective view of the air filter device of FIG. 1 from oblique behind;

FIG. 4 shows a front view of the base plate of the air filter device of FIG. 1;

FIG. 5 shows a longitudinal section of the air filter device of FIG. 1, wherein the view is cut along the section line A marked in FIG. 4, and wherein FIG. 1 depicts a detailed view of section B marked in FIG. 5;

FIG. 6 shows a perspective view of the filter cartridge of FIG. 1 from diagonally in front;

FIG. 7 shows a perspective view of the filter cartridge of FIG. 1 from oblique behind;

FIG. 8 shows a perspective view of the adapter element of FIG. 1 from diagonally in front;

FIG. 9 shows a perspective view of the adapter element of FIG. 1 from oblique behind;

FIG. 10 shows a schematic view of an embodiment of a plant building air filtration system comprising the air filter device;

FIG. 11 shows in longitudinal section a second embodiment of the air filter device according to the present invention comprising a second embodiment of an adapter element according to the present invention as well as a filter cartridge being similar to the first embodiment of the filter cartridge, which filter cartridge may be replaced according to a method of the present invention;

FIG. 12 shows a perspective view of the air filter device of FIG. 11 from diagonally in front;

FIG. 13 shows a perspective view of the air filter device of FIG. 11 from oblique behind;

FIG. 14 shows a front view of the base plate of the air filter device of FIG. 11;

FIG. 15 shows in smaller magnification a longitudinal section of the air filter device of FIG. 11, wherein the view is cut along the section line A marked in FIG. 14, and wherein FIG. 11 depicts a detailed view of section B marked in FIG. 15;

FIG. 16 shows a perspective view of the filter cartridge of FIG. 11 from diagonally in front;

FIG. 17 shows a perspective view of the filter cartridge of FIG. 11 from oblique behind;

FIG. 18 shows a perspective view of the adapter element of FIG. 11 from diagonally in front;

FIG. 19 shows a perspective view of the adapter element of FIG. 11 from oblique behind;

FIG. 20 shows in longitudinal section a third embodiment of the air filter device according to the present invention comprising a third embodiment of an adapter element according to the present invention as well as a filter cartridge being similar to the first embodiment of the filter cartridge, which filter cartridge may be replaced according to a method of the present invention;

FIG. 21 shows a perspective view of the air filter device of FIG. 20 from diagonally in front;

FIG. 22 shows a perspective view of the air filter device of FIG. 20 from oblique behind;

FIG. 23 shows a front view of the base plate of the air filter device of FIG. 20;

FIG. 24 shows a longitudinal section of the air filter device of FIG. 20, wherein the view is cut along the section line A marked in FIG. 23, and wherein FIG. 20 depicts a detailed view of section B marked in FIG. 24;

FIG. 25 shows a perspective view of the filter cartridge of FIG. 20 from diagonally in front;

FIG. 26 shows a perspective view of the filter cartridge of FIG. 20 from oblique behind;

FIG. 27 shows a perspective view of the adapter element of FIG. 20 from diagonally in front;

FIG. 28 shows a perspective view of the adapter element of FIG. 20 from oblique behind;

FIG. 29 shows in longitudinal section a fourth embodiment of the air filter device according to the present invention comprising a fourth embodiment of an adapter element according to the present invention as well as an embodiment of a filter cartridge being similar to the first embodiment of the filter cartridge, which filter cartridge may be replaced according to a method of the present invention;

FIG. 30 shows a perspective view of the air filter device of FIG. 29 from diagonally in front;

FIG. 31 shows a perspective view of the air filter device of FIG. 29 from oblique behind;

FIG. 32 shows a front view of the base plate of the air filter device of FIG. 29;

FIG. 33 shows a longitudinal section of the air filter device of FIG. 29, wherein the view is cut along the section line A marked in FIG. 32, and wherein FIG. 29 depicts a detailed view of section B marked in FIG. 33;

FIG. 34 shows a detailed view of section C marked in FIG. 33;

FIG. 35 shows a perspective view of the filter cartridge of FIG. 29 from diagonally in front;

FIG. 36 shows a perspective view of the filter cartridge of FIG. 29 from oblique behind;

FIG. 37 shows a perspective view of the adapter element of FIG. 29 from diagonally in front;

FIG. 38 shows a perspective view of the adapter element of FIG. 29 from oblique behind;

FIG. 39 shows in longitudinal section a fifth embodiment of the air filter device according to the present invention comprising a fifth embodiment of an adapter element according to the present invention as well as a second embodiment of a filter cartridge according to the present invention, which filter cartridge may be replaced according to a method of the present invention;

FIG. 40 shows a perspective view of the air filter device of FIG. 39 from diagonally in front;

FIG. 41 shows a perspective view of the air filter device of FIG. 39 from oblique behind;

FIG. 42 shows a longitudinal section of the air filter device of FIG. 39, wherein FIG. 39 is a detailed view of section B marked in FIG. 42;

FIG. 43 shows a perspective view of the filter cartridge of FIG. 39 from diagonally in front;

FIG. 44 shows a perspective view of the filter cartridge of FIG. 39 from oblique behind;

FIG. 45 shows a perspective view of the adapter element of FIG. 39 from diagonally in front;

FIG. 46 shows a perspective view of the adapter element of FIG. 39 from oblique behind;

FIG. 47 shows in longitudinal section a sixth embodiment of the air filter device according to the present invention comprising a sixth embodiment of an adapter element according to the present invention as well as the second embodiment of the filter cartridge, which filter cartridge may be replaced according to a method of the present invention;

FIG. 48 shows a perspective view of the air filter device of FIG. 47 from diagonally in front;

FIG. 49 shows a perspective view of the air filter device of FIG. 47 from oblique behind;

FIG. 50 shows a longitudinal section of the air filter device of FIG. 47, wherein FIG. 47 is a detailed view of section B marked in FIG. 50;

FIG. 51 shows a perspective view of the filter cartridge of FIG. 47 from diagonally in front;

FIG. 52 shows a perspective view of the filter cartridge of FIG. 47 from oblique behind;

FIG. 53 shows a perspective view of the adapter element of FIG. 47 from diagonally in front;

FIG. 54 shows a perspective view of the adapter element of FIG. 47 from oblique behind;

FIG. 55 shows in longitudinal section a seventh embodiment of the air filter device according to the present invention comprising a seventh embodiment of an adapter element according to the present invention as well as the second embodiment of the filter cartridge, which filter cartridge may be replaced according to a method of the present invention;

FIG. 56 shows a perspective view of the air filter device of FIG. 55 from diagonally in front;

FIG. 57 shows a perspective view of the air filter device of FIG. 55 from oblique behind;

FIG. 58 shows a front view of the base plate of the air filter device of FIG. 55;

FIG. 59 shows a perspective view of the adapter element of FIG. 55 from diagonally in front;

FIG. 60 shows a perspective view of the adapter element of FIG. 55 from oblique behind;

FIG. 61 shows a perspective view of an eighth embodiment of an adapter element comprising axial ramps according to the present invention from diagonally behind;

FIG. 62 shows a perspective view of the adapter element of FIG. 61 from diagonally in front;

FIG. 63 shows a perspective view of a filter cartridge according to an embodiment of the present invention from diagonally in front, which may be paired with the adapter element of FIG. 61, and may be replaced according to the method of the present invention;

FIG. 64 shows a side view of a filter cartridge mounted onto a ninth embodiment of an adapter element comprising radial ramps according to the present invention;

FIG. 65 shows a perspective view of the filter cartridge mounted on the adapter element of FIG. 64; and

FIG. 66 shows a partial front view of the filter cartridge of FIG. 64.

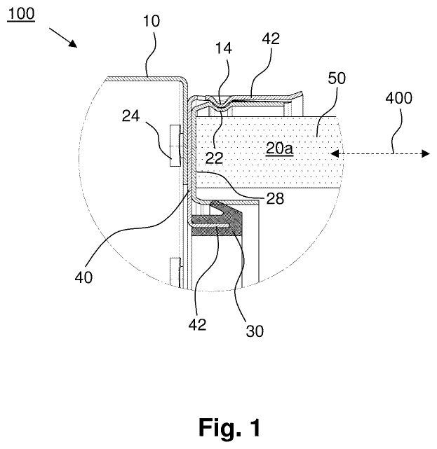

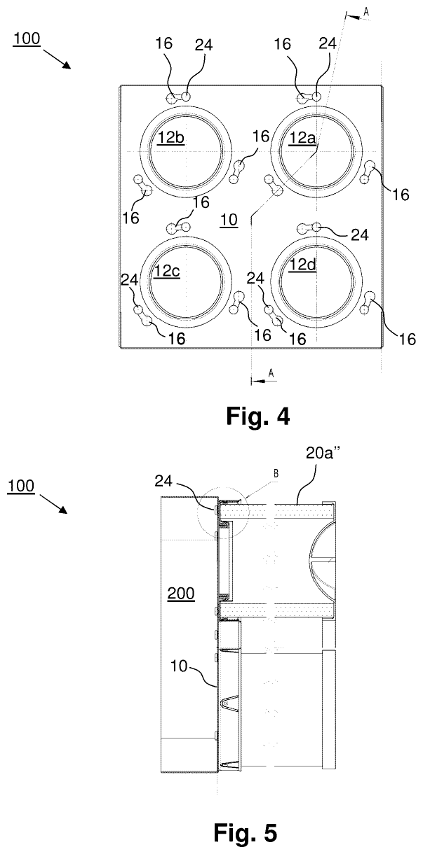

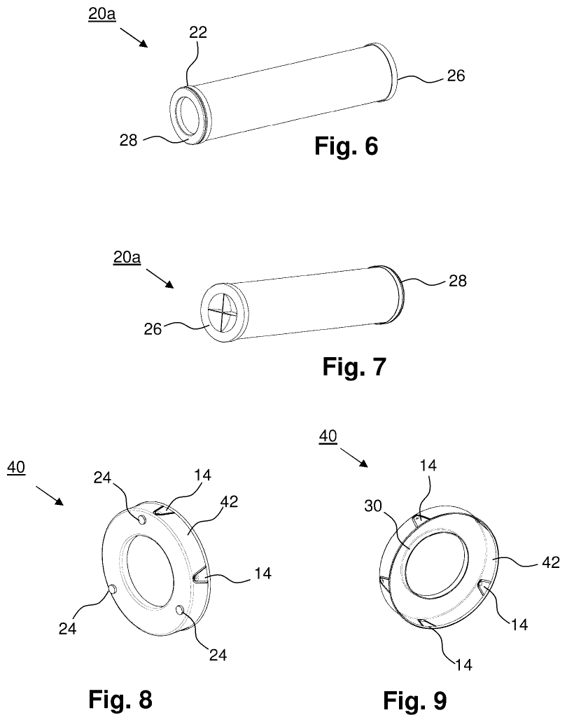

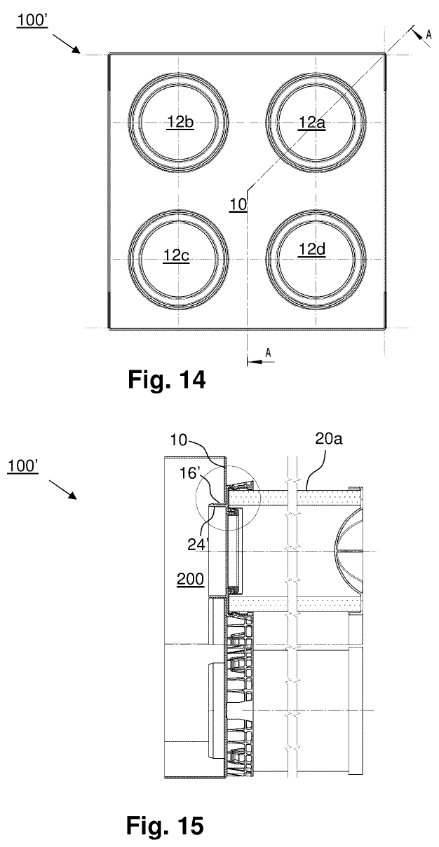

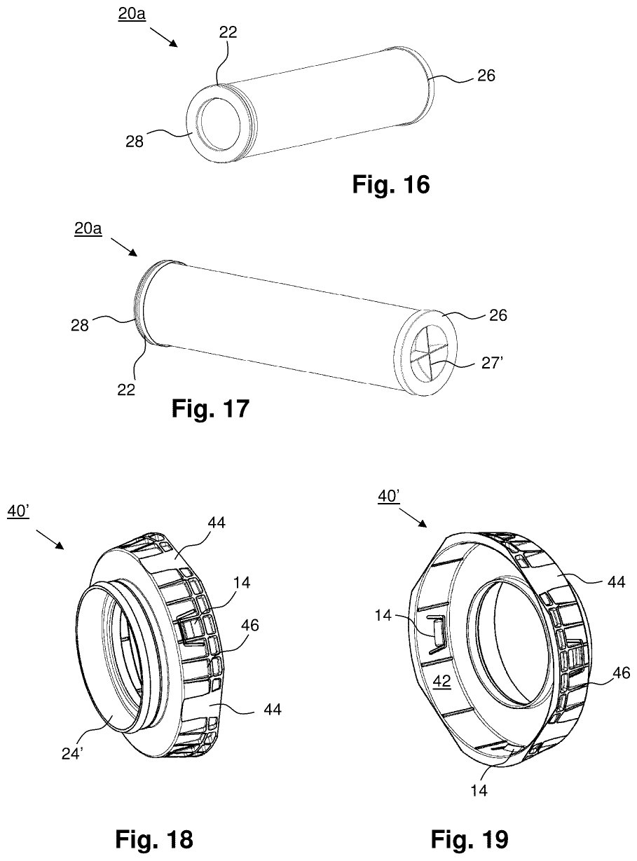

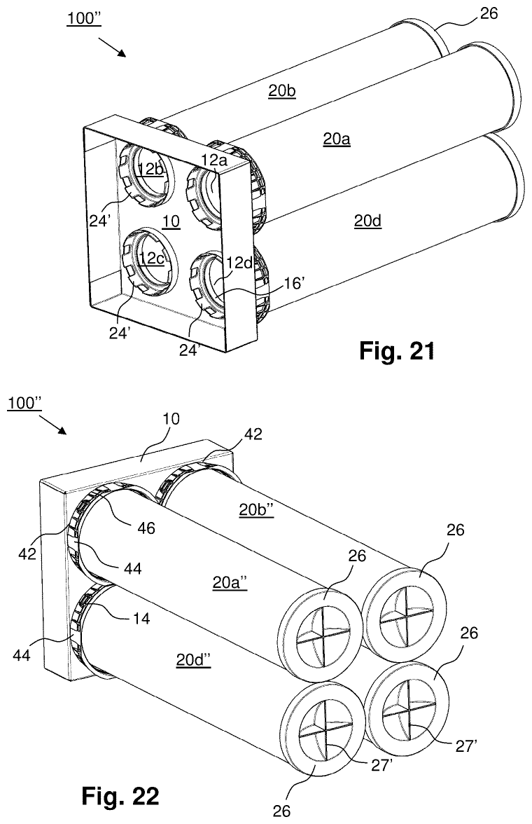

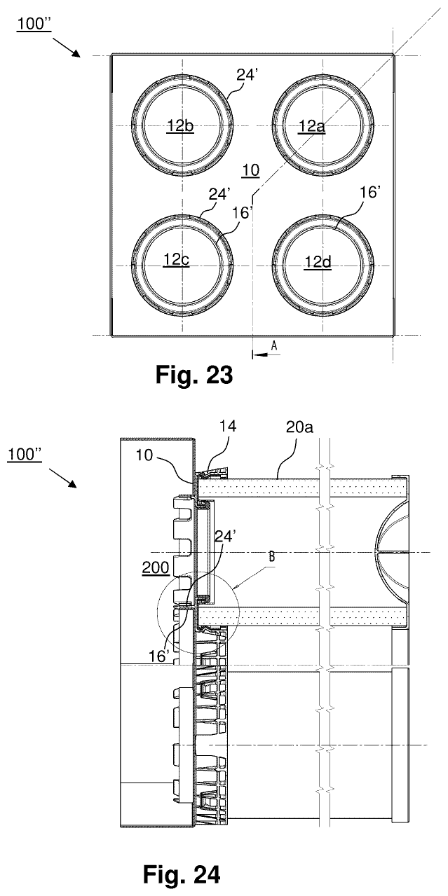

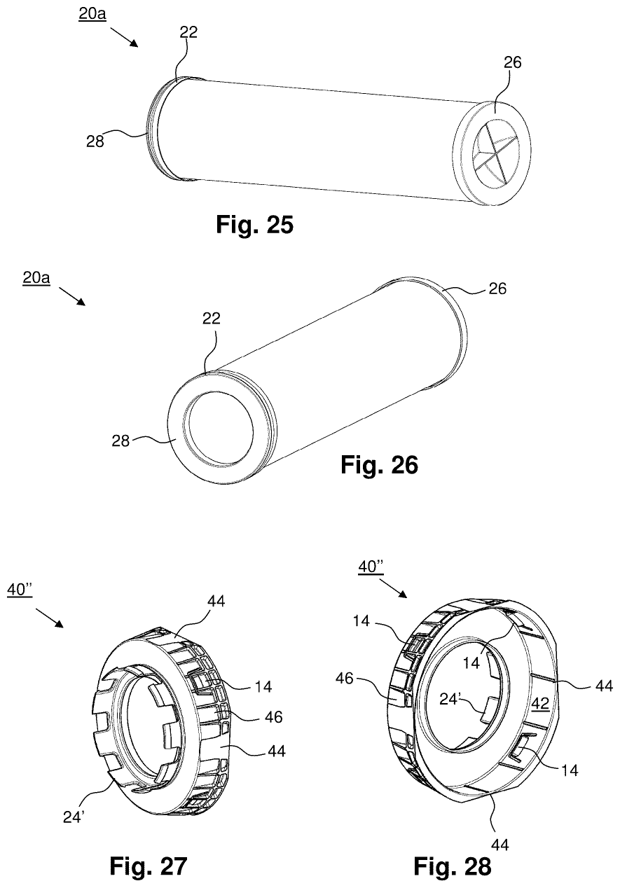

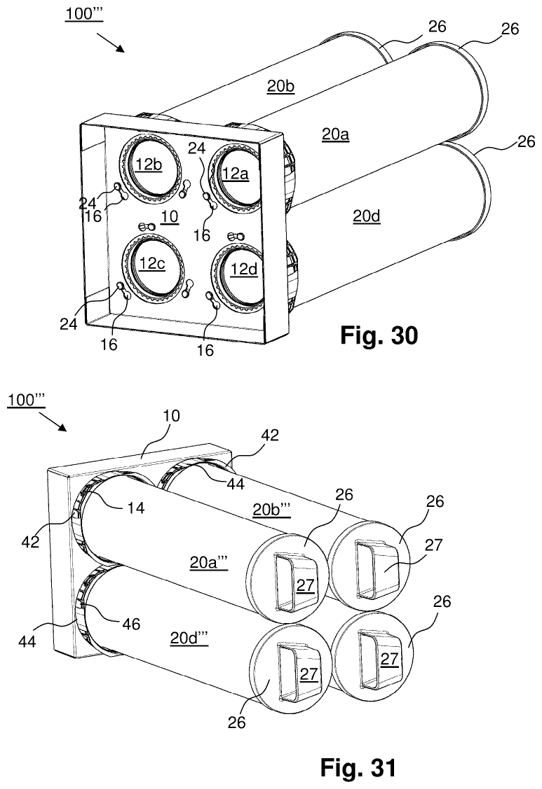

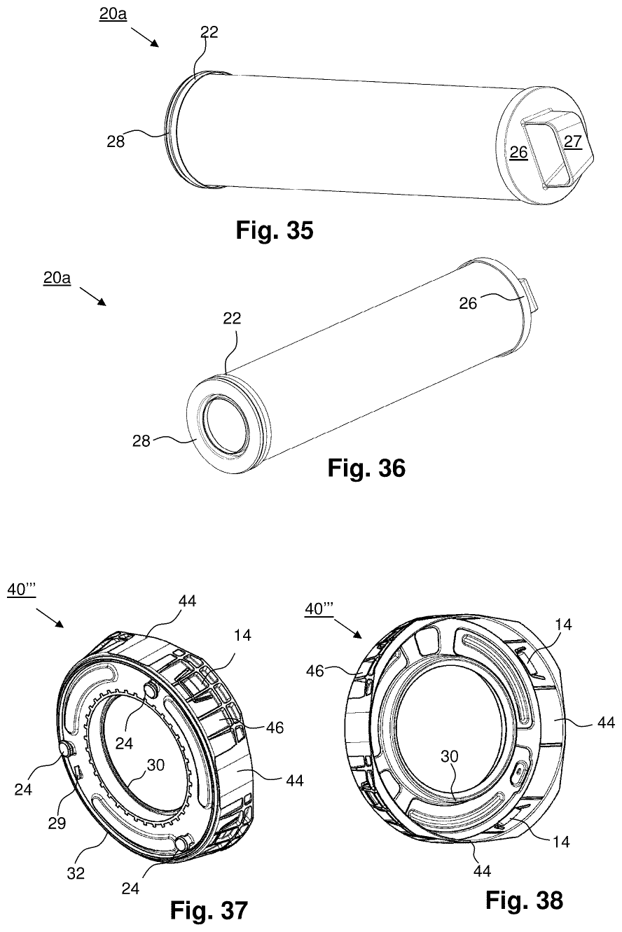

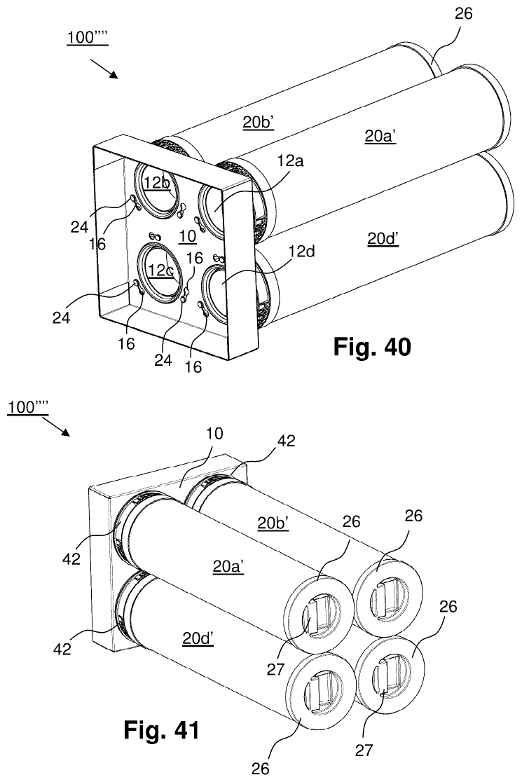

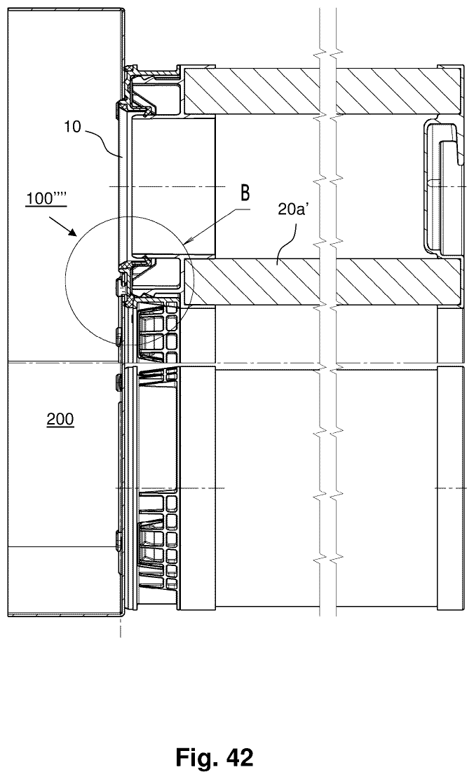

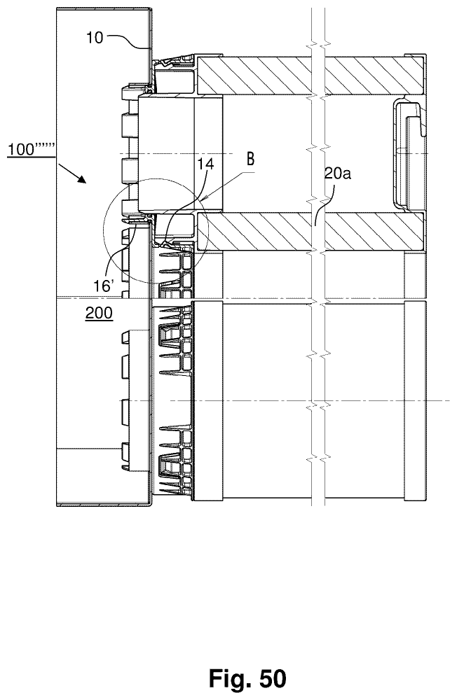

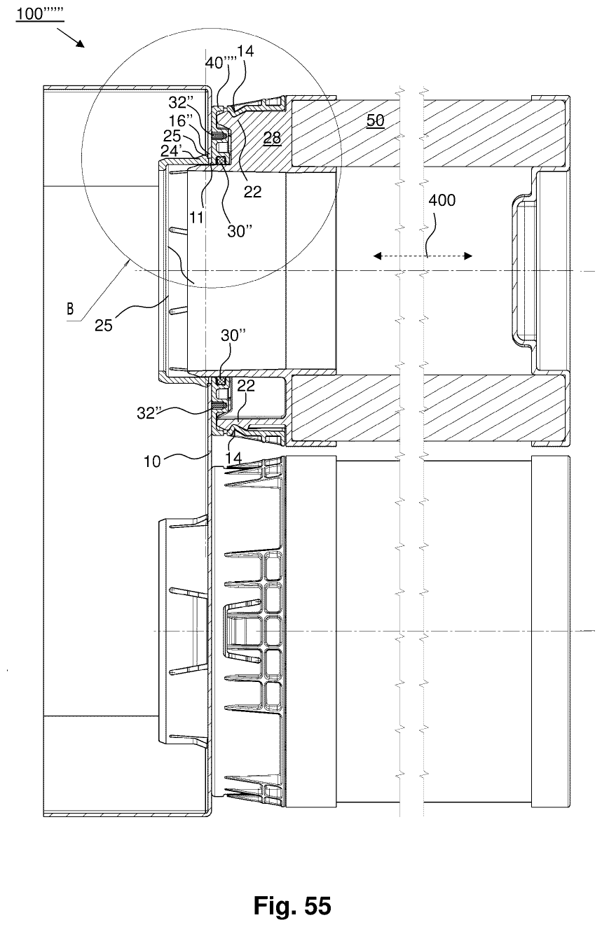

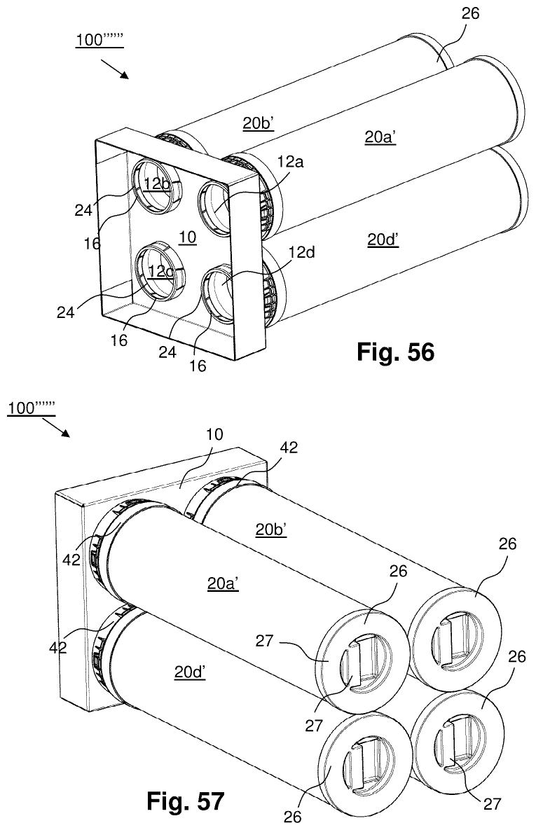

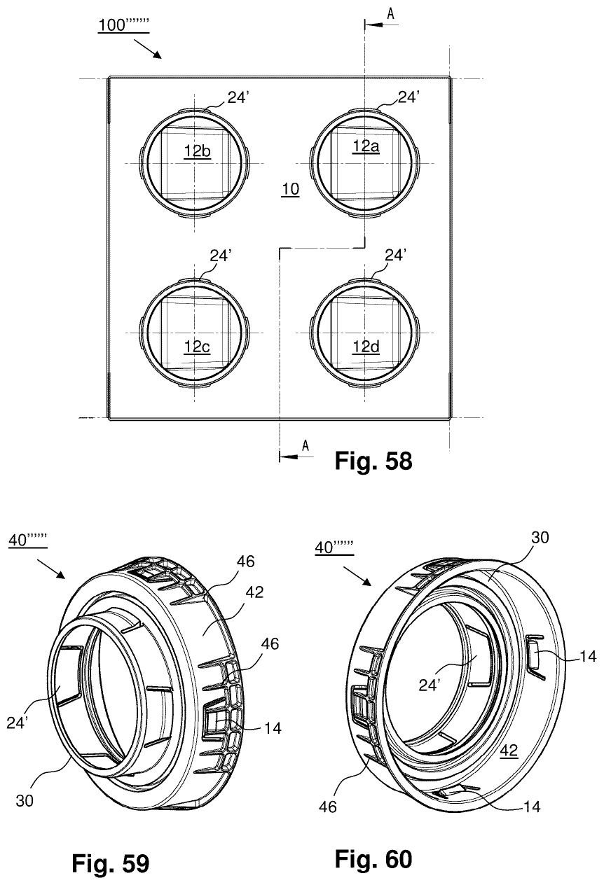

The same reference numerals are used for corresponding same or similar parts in FIGS. 1 to 60.

### DETAILED DESCRIPTION

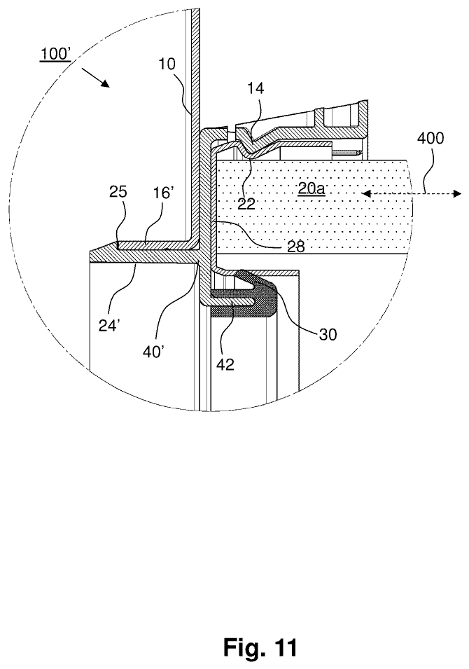

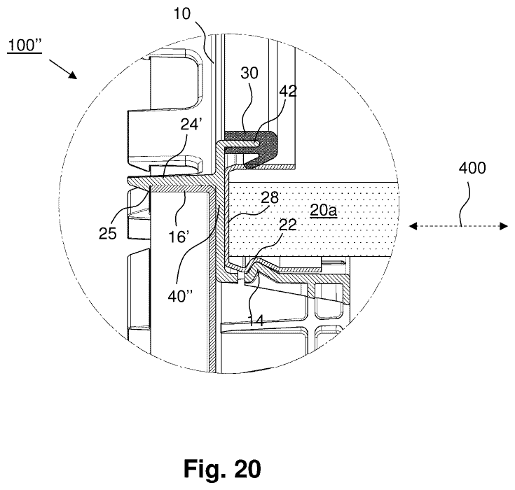

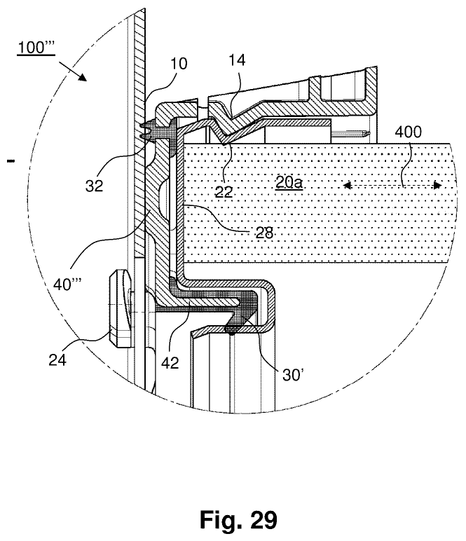

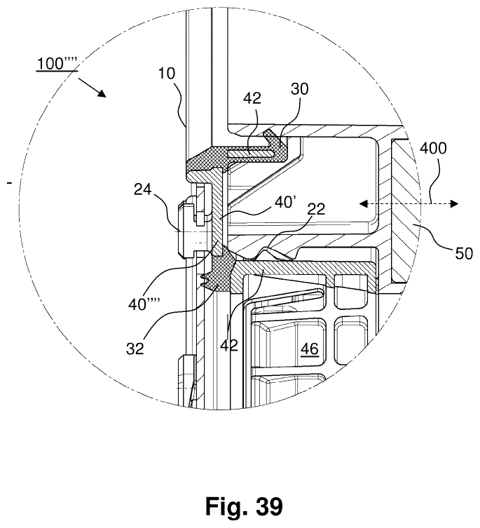

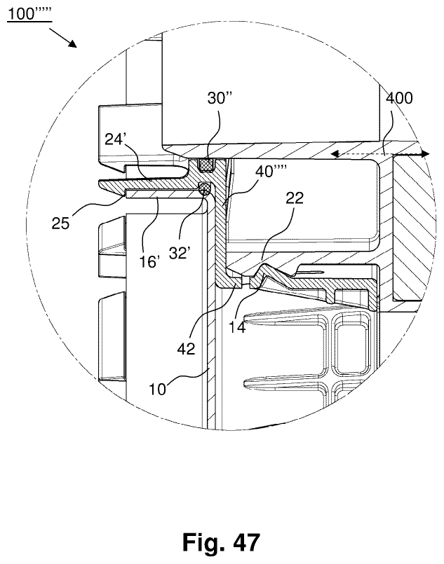

In order to avoid unnecessary repetitions, the following description regarding the embodiments, characteristics and advantages of the present invention relates (unless stated otherwise)
to the first embodiment of the air filter device 100 according to the present invention comprising a first embodiment of a filter cartridge 20a, 20b, 20c, 20d according to the present invention and a first embodiment of an adapter element 40 according to the present invention (cf. FIGS. 1 to 38) as well as
to the second embodiment of the air filter device 100′ according to the present invention comprising an embodiment of a filter cartridge 20a, 20b, 20c, 20d being similar to the first embodiment of the filter cartridge and a second embodiment of an adapter element 40′ according to the present invention (cf. FIGS. 11 to 19) as well as
to the third embodiment of the air filter device 100″ according to the present invention comprising an embodiment of a filter cartridge 20a, 20b, 20c, 20d being similar to the first embodiment of the filter cartridge and a third embodiment of an adapter element 40″ according to the present invention (cf. FIGS. 20 to 28), as well as
to the fourth embodiment of the air filter device 100″ according to the present invention comprising an embodiment of a filter cartridge 20a, 20b, 20c, 20d being similar to the first embodiment of the filter cartridge and a fourth embodiment of an adapter element 40″ according to the present invention (cf. FIGS. 29 to 38), as well as
to the fifth embodiment of the air filter device 100″″ according to the present invention comprising a filter cartridge 20a′, 20b′, 20c′, 20d′ being similar to the second embodiment of the filter cartridge and a fifth embodiment of an adapter element 40″″ according to the present invention (cf. FIGS. 39 to 46), as well as
to the sixth embodiment of the air filter device 100″ according to the present invention comprising a filter cartridge 20a′, 20b′, 20c′, 20d′ being similar to the second embodiment of the filter cartridge and a sixth embodiment of an adapter element 40′″ according to the present invention (cf. FIGS. 47 to 54), as well as
to the seventh embodiment of the air filter device 100″ according to the present invention comprising a filter cartridge 20a′, 20b′, 20c′, 20d′ being similar to the second embodiment of the filter cartridge and a seventh embodiment of an adapter element 40″″ according to the present invention (cf. FIGS. 55 to 60).

All embodiments 100, 100′, 100″, 100′″, 100″, 100″, 100″ being operated according to the method of the present invention.

As depicted in FIGS. 1 to 29, the filter cartridges 20a, 20b, 20c, 20d; 20a′, 20b′, 20c′, 20d′; are connected to the base plate 10 by means of a radial snap connection 14, 22. An additional adapter element 40, 40′, 40″, 40″ is used for this purpose, which is mounted once in the base plate 10 and remains there as a service life part. Radially acting snaps 14 are integrated in the adapter element 40, 40′, 40″. These snaps 14 engage in a circumferential groove 22 located in an open-end cap or lower end plate 28, 28′ of the filer cartridges 20a, 20b, 20c, 20d, 20a′, 20b′, 20c′, 20d′. The lower end plate 28, 28′ may be formed as an injection-molded or sheet metal part and is formed corresponding to a radial sealing 30, 30′. FIG. 20 shows a first embodiment of a lower end cap, comprising a radial sealing 30 being produced separately and then mounted, e.g. clamped or glued, on the adapter element 40″ as lifetime part. FIG. 29 shows an embodiment of a radial sealing 30′ produced e.g. as two-component injection-molded part together with the adapter element 40″.

FIG. 1 depicts a longitudinal section of the adapter element 40 with radial sealing means 30 attached on a collar 42 of the adapter element 40 being designed for surrounding an axial end of the filter medium body 50 and snapped filter cartridge integrated in an upper end plate 28. Additionally, the sides of collar 42 surrounding the axial end of the filter medium body 50 provide a centering function to easily locate the correct position of the filter cartridge on the adapter element 40.

For assembling the filter cartridges to the base plate 10, the filter cartridges 20a, 20b, 20c, 20d, 20a′, 20b′, 20c′, 20d′ only need to be inserted axially into the adapter part 40, 40′, 40″, 40″. Thus, the filter cartridges may be assembled to the base plate 10 by means of an axial movement without additional rotation. Disassembly of the filter cartridge takes place by pulling, or a combined pulling-tilting movement of the filter cartridges. The radial acting snap connection 14, 22 leads to time savings during assembly and disassembly of the filer cartridges.

Thus, the filter cartridges are mounted on the base plate 10 by simply inserting them axially into an additional housing part, namely an adapter element 40, 40′, 40″, 40″ to be installed once. Each filter cartridge is attached to the adapter element 40, 40′, 40″, 40″, 40″, 40″, 40″ by means of a radial acting snap-on connection 14, 22 and the adapter element 40, 40′, 40″, 40″, 40″″, 40″, 40″ in turn is attached to the mounting base plate 10 by means of a bayonet connection 16, 24 (cf. FIGS. 1 to 10 and FIGS. 29 to 46) or by means of a form-fit connection 16′, 24′ (cf. FIGS. 11 to 28 and FIGS. 47 to 60).

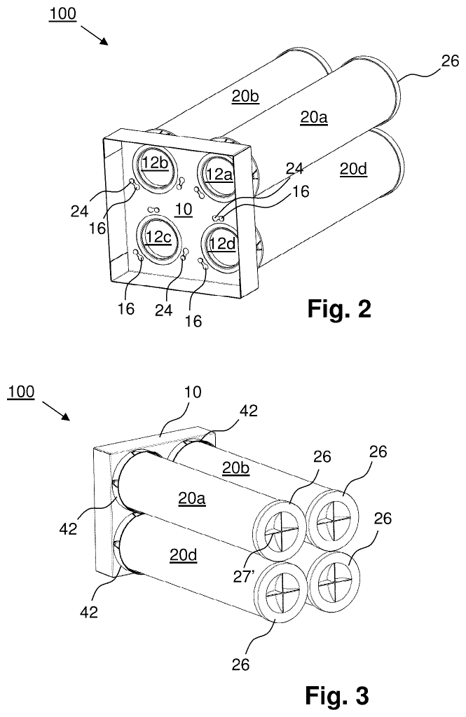

As depicted in FIGS. 2, 4, 30, 32 and 45 the bayonet fastening means 16 may be designed for example as a conventional three-hole bayonet fastening means. Thus, the adapter element 40, 40′″ may comprise three bayonet pins 24 molded thereon, which allows retrofit installation in existing filter cartridges (cf. FIG. 27). As depicted in FIG. 1, the bayonet pins 24 may be shaped in a mushroom-type, comprising at least one shaft, such as at least one tubular or cone-shaped shaft, and at least one hat, such as at least one flat or globular or cone-shaped hat.

Alternatively, to the conventional three-hole bayonet, the counter bayonet fastening means 24 may be designed for example as a simple circular hole of the base plate 10 (not shown).

As may be seen in FIG. 29, the adapter element 40″ may be fixed with bayonet 16, 24 and, additionally for securing and tightening, glued on the base plate 10.

The adapter element 40, 40′, 40″, 40″, 40″, 40″, 40″ contains four radial snap-in connection elements 14 which, during assembly, engage in a circumferential groove 22 of the lower end plate 28 of the filter cartridge and hold the filter cartridge in the end position.

Independently thereof or in connection therewith, a radially acting sealing means 30, 30′, 30″ is also integrated in the adapter piece 40, 40′, 40″, 40″, 40″″, 40″, 40″″ as a service life solution. The radial seal 30 eliminates the tolerance-related disadvantages of the axial seal 32, 32′, 32″ being compressed at the lower edge due to gravity and weight of the filter cartridge.

The radial sealing means 30, 30′, 30″ of the adapter element 40, 40′, 40″, 40″, 40″, 40″, 40″ which ensures the seal to the filter cartridge, is a service life component for reasons of sustainability. The radial sealing means 30 may be mounted, for example plugged, into the adapter component 40 as a separate component, as for example is depicted in FIG. 1, which shows a radial sealing lip 30 mounted on a sheet metal adapter element 40.

Alternatively, as for example shown in FIGS. 29 to 38, the radial sealing means 30 may be manufactured as a two-component part together with the adapter element 40″ as an injection-molded part. Thus, the radial sealing means 30 may be a radial injection-molded seal, which seals the adapter element 40″ against the filter cartridge 20a, 20b, 20c, 20d.

As depicted in FIGS. 1 to 10 with regard to the first embodiment of the adapter element 40, the radial sealing means 30 may be arranged on the adapter element 40, but it may also be arranged on the filter cartridge. Then the radial sealing means 30 would be replaced with the filter cartridge and the adapter element 40, 40′, 40″, 40′″ would have only an at least partly circumferential wall 42 or snap connection collar as counter sealing surface (not shown).

The adapter element 40 depicted in FIGS. 1 to 10 is made of sheet metal. The adapter element 40 depicted in FIGS. 11 to 38 is made of plastic, which is recognizable by a ribbing.

The second embodiment of an adapter element 40′ according to the present invention as well as the third 40″, sixth 40″ and seventh 40″″″″ embodiment of an adapter element according to the present invention is mounted on the base plate 10 by means of a form-fit connection 16′, 24′ instead of a bayonet connection 16, 24. This leads to the advantage, that bayonet openings are no longer required and the base plate 10 may be manufactured more easily.

In more detail, as depicted in FIGS. 11, 12, 20, 21, 47, 48 and 55 the counter form-fit connection means 24′ of the adapter element 40′; 40″, 40″, 40″ of the second, the third, the sixth and the seventh embodiment is designed as at least one snapping collar, for example a flow opening tubular nozzle segment, being designed to extend through at least one of the flow openings 12a, 12b, 12c, 12d of the base plate 10 and being formed at least partly circumferential.

The snapping collar 24′ is fitted with a locking recess, for example with an undercut 25, which is designed to engage directly or indirectly with the edge of the base plate 10 adjacent to an opening (11, 12a, 12b, 12c, 12d), of the base plate 10, for example adjacent to a fixation opening 11 or to a flow opening 12a, 12b, 12c, 12d, to form the form-fit connection.

In the second 100′, third 100″ and sixth 100″″ embodiment of the air filter device of the present invention, for forming a form-fit connection with the counter form-fit connection means 24′ of the adapter element 40′, 40″, 40″ the further mounting device 16′ of the base plate 10 is designed as a collar surrounding the flow opening 12a, 12b, 12c, 12d, for example extending perpendicularly with the sheet metal piece of the base plate 10.

As depicted in FIG. 55, the seventh embodiment 40″ of the adapter element is similar to the embodiments of FIGS. 11, 20 and 47 but spares the collar 16′ of the base plate 10. In the seventh embodiment of the air filter device 100″″″ of the present invention, the edge of the base plate 10 adjacent to a fixation opening 11, such as a hole, serves as further mounting device 16″. Thus, the snapping collar 24′ of the seventh embodiment of the adapter element 40″″″″ is designed to engage directly with the edge 16″ of the base plate 10 adjacent to the fixation opening 11 of the base plate 10. The fixation opening 11, for example, may be punched or cut into the base plate 10. As the snap fit elements 14 of the adapter 40″″″″ are directly snapped onto the plate of the base plate 10, the only tolerance is the thickness variation of the base plate 10, for example of the sheet metal of the base plate 10. As a further technical effect, the base plate 10 may thus be produced easier.

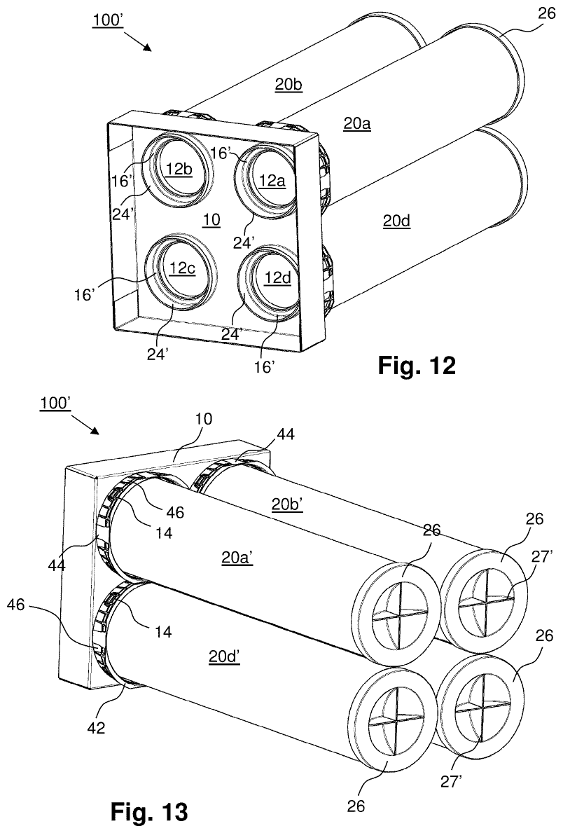

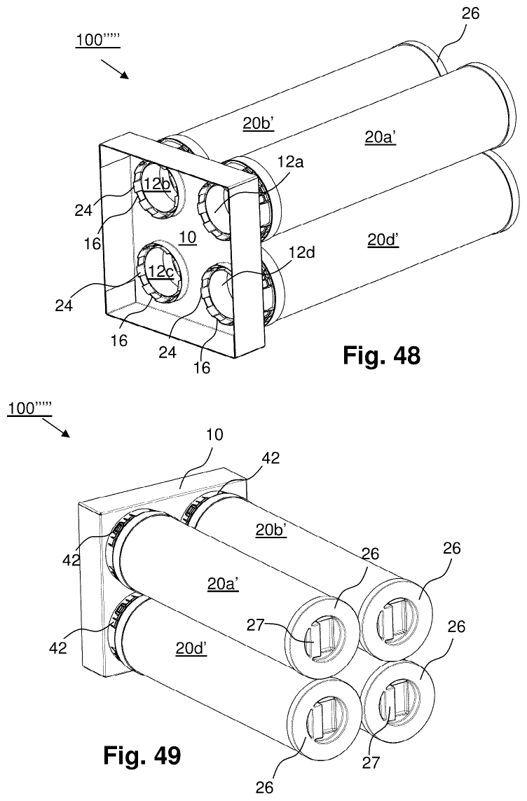

In the second embodiment of the adapter element 40′, the snapping collar is designed continuously (cf. FIGS. 11 and 12) and in the third, sixth and seventh embodiment of the adapter element 40″, 40″, 40″″″″ the snapping collar 24′ is designed discontinuously (cf. FIGS. 20, 21 and 48). Alternatively, in the third, sixth and seventh embodiment of the adapter element 40″, 40″, 40″″ depicted in FIGS. 20 and 48 the counter form-fit connection means 24′ is interrupted to reduce the assembly forces required for connecting the counter form-fit connection means 24′ on the base plate 10. The snapping collar 24′ may be for example implemented as an interrupted snap collar.

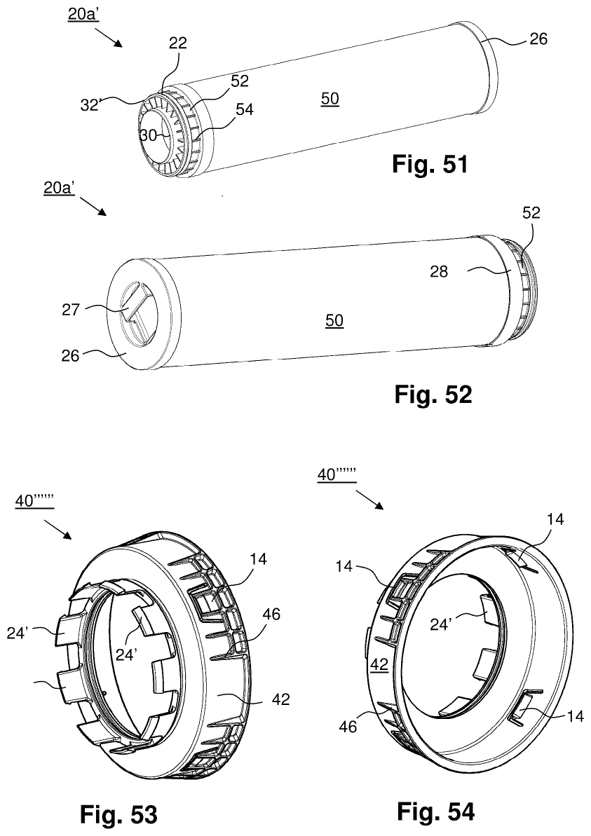

The filter cartridge of the seventh embodiment of the air filter device may be the same as the filter cartridge depicted in FIGS. 51 and 52.

Latching of the second embodiment of the adapter element 40′ with respect to the filter cartridge is in the second embodiment of the adapter element 40′ like the latching of the first embodiment of the adapter element 40.

The interface between the filter cartridge and the base plate 10 comprises in all embodiments an open-end disc 28 with at least one circumferential groove 22 on an outer shell surface. Groove shape may vary depending on forces to be achieved. A semi-circular groove for example provides lower clipping and holding forces than if an asymmetrical groove is inserted. An asymmetrical groove 22 may be for example a triangle comprising one angle with 60 degrees and one with 30 degrees. To adapt release forces to cartridge designs, the shape of the groove 22 may be varied. For example, for a heavy filter cartridge an asymmetrical groove 22 might be chosen and for a lighter filter cartridge a semi-circular groove 22 might be applied to required lower disassembly forces.

The filter cartridge 20a, 20b, 20c, 20d depicted in FIGS. 11 to 19 differs from the filter cartridge design depicted in FIGS. 1 to 10 in the form of the groove 22. In the filter cartridge 20a, 20b, 20c, 20d depicted in FIGS. 1 to 10 the groove 22 of the end cap 28 is in cross section formed round or circumferential and in the filter cartridge 20a, 20b, 20c, 20d depicted in FIGS. 11 to 19 the groove 22 of the end cap 28 is formed asymmetrical, e.g. triangular, for providing a stronger locking connection with the snap connection means 14.

The radial sealing means 30 depicted in FIGS. 11 to 28 is identical to the type depicted in FIGS. 1 to 10. The sealing means 30 is mounted with sealing lips, arranged on the adapter element 40′, in more detail on a tubular nozzle segment 42 of the adapter element 40′.

As depicted in FIGS. 31 and 36 a handle 27 or grip function may be integrated into the closed end cap or upper end plate 26 of the filter cartridge. The handle 27 may be combined with any embodiment of the filter cartridges 20a, 20b, 20c, 20d, 20a′, 20b′, 20c′, 20d′.

FIGS. 3, 13, 22 depict a second embodiment of the handle 27′, namely crossed rips, for axial movement of the filter cartridge 20a, 20b, 20c, 20d; 20a′, 20b′, 20c′, 20d′.

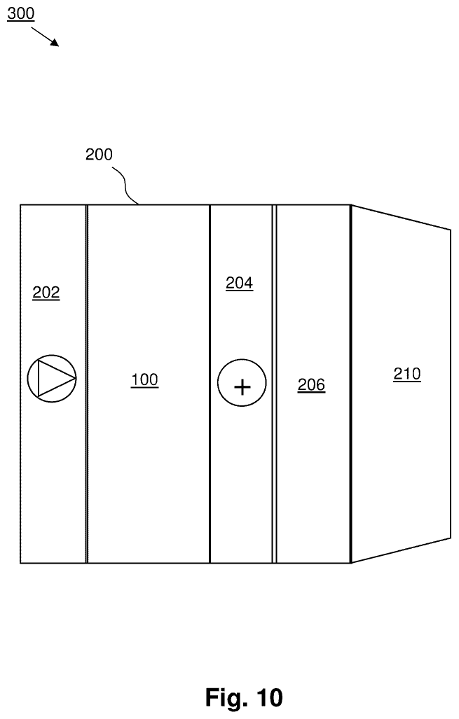

As depicted in FIG. 10 the base plate 10 of the air filter device is designed to fit into a filter housing 200 of a plant for gas filtration, for example for a building air filtration, in such a way that it is arranged between an upstream unfiltered air side or raw air side, and a downstream filtered air side or clean air side.

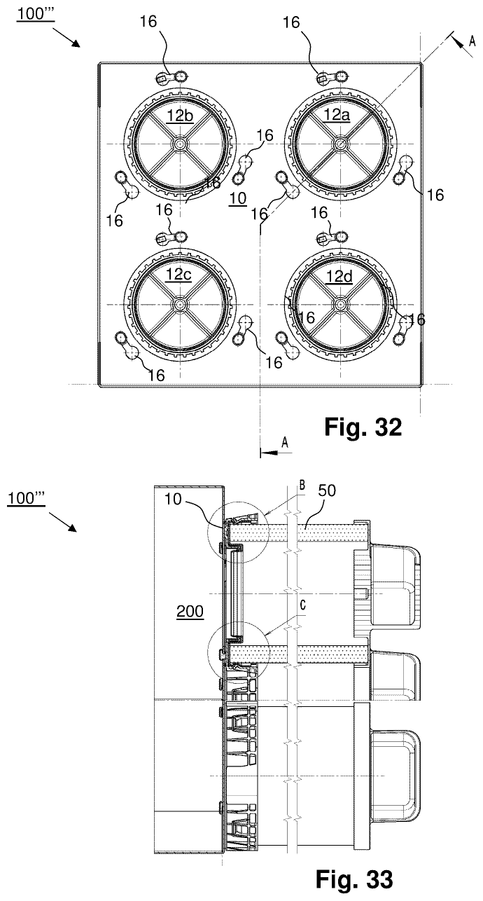

As depicted in FIGS. 37, 38 the adapter element 40″ is provided with four clips 14, which must always be in the same position to align the bayonet pins 24. In the base plate 10 there are only three bayonet holes 16 (cf. FIG. 32). Since there are four clips 14 (cf. FIG. 38), two of which should always be at the top at 45 degrees, the wall of the adapter element 40″ is partially flattened to define the arrangement of the pins 24 so that the bayonet 16, 24 is mounted correctly.

In contrary to the flattened parts, the adapter wall with ribs depicted in FIGS. 37, 38, 27, 28 is relatively stiff and stable. The snap connection means or clip noses 14 are arranged at an inner area of a snap connection collar 42 of the adapter element 40″. Rips are arranged at an outer perimeter of the snap connection collar 42 on the back of the clip noses 14. Due to the stiff wall with ribs of the snap connection collar, the clip nose 14 gets more force. Due to flattening of the wall of the snap connection collar 42, the entire snap connection collar ring expands when pushed onto nose 14 and contracts when snapped into place 22. Thus, not only clip nose 14 brings up force, but also the entire snap connection collar 42.

Moreover, FIG. 37 depicts an anti-rotation device comprising a locking means 29, namely a single hump or nose. When finally mounted, this nose 29 snaps in the punched-out bayonet hole 16 of the base plate 10. The mounted position is seen in FIG. 32.

The third, sixth and seventh embodiment of the adapter element 40″, 40″, 40″ of the present invention (cf. FIGS. 39, 47 and 55) are similar to the second embodiment of the adapter element 40′ depicted in FIG. 11. All embodiments 40′, 40″, 40″, 40′″ comprise
the snapping collar 24′ for connecting the adapter element with the form fit connection element 16′, 16″ of the base plate 10,
the snap connection means 14 for connecting the adapter element with the filter cartridge 20a, 20b, 20c, 20d; 20a′, 20b′, 20c′, 20d′ and
the radial seal 30, 30′, 30″.

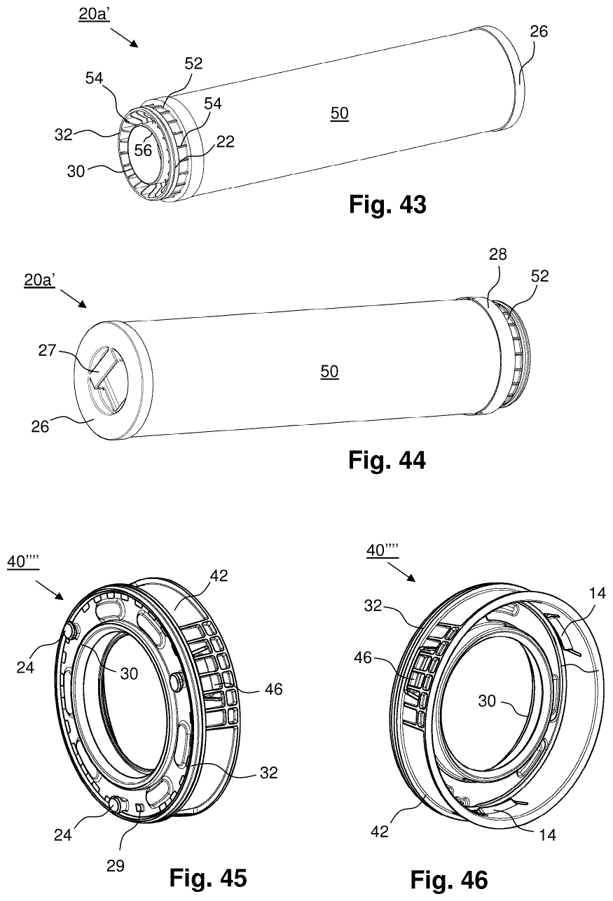

The sixth and seventh embodiment of the adapter element 40″, 40″ of the present invention differ from the second embodiment 40′ in the sealing concept of the adapter element against the base plate 10 as well as the adapter element against the filter cartridge. The sealing interface between the adapter element 40′ and the base plate 10 of the sixth embodiment of an air filter device depicted in FIG. 47 comprises instead of an axial sealing means provided by two component injection molding or an injected adhesive element, such as glue material, a circular or quadrangular axial sealing means 32′, for example an O-ring. Moreover, the sealing interface between the filter cartridge 20a′, 20b′, 20c′, 20d′ and the adapter element 40′″, 40″ comprises a circular or quadrangular radial sealing means 30″, for example a quad ring. This leads to the advantage of reduced complexity of the sealing means 32′, 30″. As depicted in FIG. 43 and FIG. 51, the sealing interface 56 comprises a raised rim to provide a centering function to easily locate the correct position of the filter cartridge 20a′, 20b′, 20c′, 20d′ on the adapter element 40″, 40″″

In the seventh embodiment of an air filter device 100″″, depicted in FIG. 55, the axial sealing means 32″ between the adapter element 40″ and the base plate 10 is a cylindrical sealing means 32 that may be a seal which has been pierced by a hose, such as a portion of rubber hose. As may be seen from FIG. 55, the axial seal 32 is held tightly at the adapter element 40″ in a circumferential groove of the adapter element 40″″″.

As may be seen in FIGS. 18, 19, 27, 28, 37, 38, 53, 54, the snap connection collar 42 of the adapter element 40′; 40″; 40″, 40″, 40″, 40″ comprises in the area of the snap connection means 14 ribs 46 designed for reinforcing the retention force for mounting the filter cartridge 20a, 20b, 20c, 20d; 20a′, 20b′, 20c′, 20d′ to the base plate 10.

The fifth, sixth and seventh embodiment of the adapter element 40″, 40″, 40″ differ from the first to fourth embodiment of an adapter element 40, 40′, 40″, 40″ in that the outer diameter of the snap connection collar 42 is circular, for example that the snap connection collar 42 is a tubular socket section. This leads to the advantage, that the filter cartridge may be mounted at any angle of rotation to the adapter element 40″, 40″, 40″.

A further difference is that the snap connection collar 42 as well as the connection interface 52 of the open end cap 28 of the fifth, sixth and seventh embodiment of the air filter device are longer, i.e. extend more in axial direction, compared to the snap connection collar 42 and the connection interface of the first to fourth embodiment of the air filter device according to the present invention.

As may be seen from FIGS. 43 to 46, 51 to 54, 56 and 57 at the fifth, sixth and seventh embodiment of the adapter element 40″″, 40″, 40″ the snap connection collar 42 comprises the same outer diameter as the open end cap 28 of the filter cartridge 20a′, 20b′, 20c′, 20d′. This leads to the advantage that there is enough space for the snap connection collar 42 to be formed circular and to be mounted to the mounting device 16′, 16″ of the base plate 10.

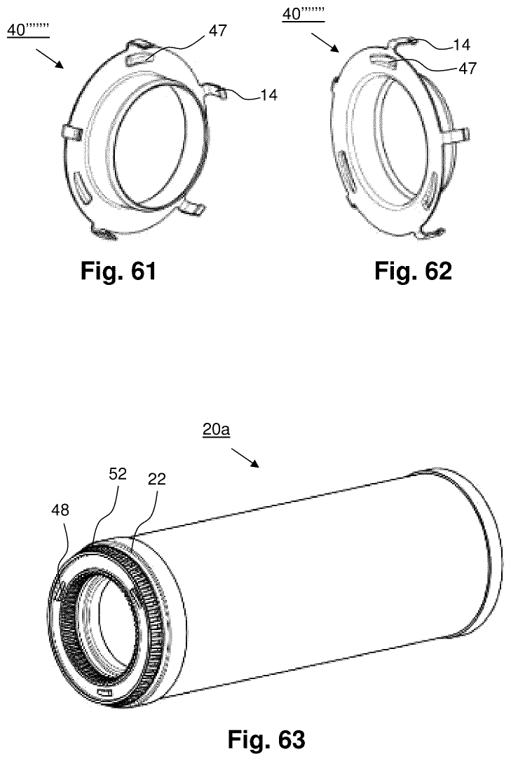

FIGS. 61 to 63 show an eighth embodiment of the adapter element 40″, in which a face of the adapter element 40″ facing the filter cartridge 20a comprises three axial ramps 47. The connection interface 52 of filter cartridge 20a comprises three corresponding ramp partners in the form of second ramps 48. The snap connection means of adapter element 40″ are a plurality of fingers 14, here five fingers. The snap connection fingers 14 engage in the circumferential groove 22 of the filter cartridge 20a previously described. To move the filter cartridge 20a to its unconnected or unlocked position, the filter cartridge 20a may be rotated, thereby urging the filter cartridge 20a along a sloping surface of the ramps 47 and the corresponding sloping surface of the second ramps 48, such that the filter cartridge 20a is urged axially away from the filter cartridge 20a and partially out of the snap connection fingers 14.

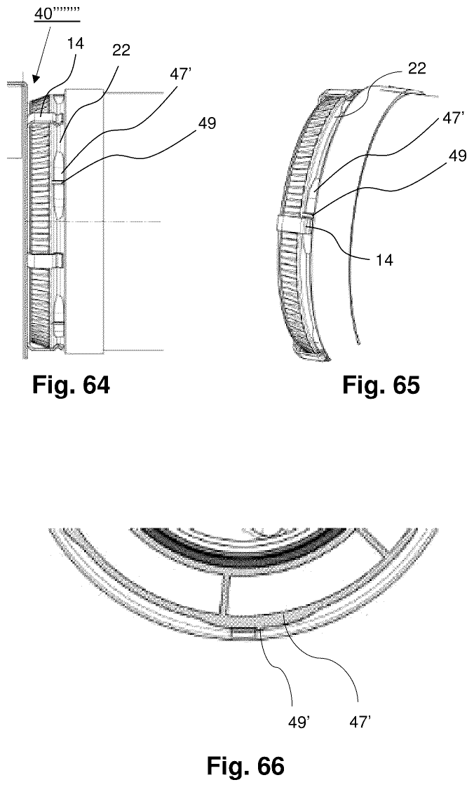

FIGS. 64 to 66 show a ninth embodiment of the adapter element 40″, in which a radial face of the filter cartridge 20a, where the counter snap connection means being circumferential groove 22 is arranged, comprises at least one radial ramp 47′. The radial ramp 47′ comprises two opposing sloping surfaces which meet at a highest point where stop rib 49 is provided. To move the filter cartridge 20a to its unconnected or unlocked position, the filter cartridge 20a may be rotated, thereby urging the filter cartridge 20a along one of the sloping surfaces of the radial ramp 47′ until the snap connection fingers 14 meet the stop rib 49, thereby stopping further rotation. At this point, the snap connection fingers 14 are partially out of the circumferential groove 22 and the demounting force is minimal.

All embodiments depicted in FIGS. 1 to 60 enable fast, simple, reliable error-free mounting of the filter cartridge on the base plate 10 and improves the quality of the seal between the cartridge and the base plate 10 through the use of a radial lifetime seal 30.

### REFERENCE NUMBERS

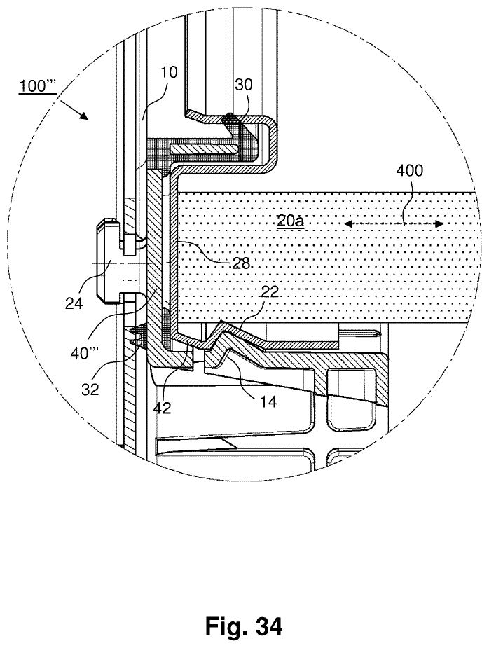

10 base plate, for example mounting frame, such as sheet metal rack, for example sheet metal housing, designed to fit in a filter housing 200 or in a filter unit 200
11 fixation opening
12a flow opening of the base plate 10
12b further flow opening of the base plate 10
12c further flow opening of the base plate 10
12d further flow opening of the base plate 10
14 mounting device or fitting device of the base plate 10 or of the adapter element 40, 40′, 40″, 40″ for assembling one filter cartridge 20a, 20b, 20c, 20d; 20a′, 20b′, 20c′, 20d′ each, for example at least one snap connection means, such as at least one snap-on means, for example an engagement hook or snap arm or snap-fit or a radially acting snap
16 further mounting device or fitting device of the base plate 10 for assembling one filter cartridge 20a, 20b, 20c, 20d; 20a′, 20b′ 20c′, 20d′ each, for example at least one bayonet fastening element, such as an engagement recess, for example a longitudinal slot at the end of which a short transverse slot is attached at a right angle; cf. FIGS. 1 to 10 and FIGS. 29 to 38;
16′ further mounting device or fitting device of the base plate 10 for assembling one filter cartridge 20a′, 20b′, 20c′, 20d′; 20a′, 20b′, 20c′, 20d′ each, for example at least one form-fit connection element, such as a horizontal nose-piece or snap band or snap type or collar, for forming a form-fit connection or form-lock connection with a counter form-fit connection element 24′ assigned to the adapter element 40′, 40″, 40″; cf. FIGS. 11 to 28 and 47;
16″ further mounting device or fitting device of the base plate 10 for assembling one filter cartridge 20a, 20b, 20c, 20d; 20a′, 20b′, 20c′, 20d′ each, for example at least one form-fit connection element, such as an edge adjacent to a fixation opening 11 of the base plate 10, for forming a form-fit connection or form-lock connection with a counter form-fit connection element 24′ assigned to the seventh embodiment of the adapter element 40″″″″; cf. FIG. 55
20a filter cartridge, for example adsorber cartuses or adsorption catalyst, for example cylinder shaped; first embodiment cf. FIGS. 2, 3, 6, 7, 12, 13, 16, 17, 22, 24, 25, 26, 29, 30, 31, 33, 34, 35, 36
20b further second filter cartridge, for example adsorber cartuses or adsorption catalyst, for example cylinder shaped; first embodiment cf. FIGS. 2, 3, 6, 7, 12, 13, 16, 17, 22, 24, 25, 26, 29, 30, 31, 33, 34, 35, 36
20c further third filter cartridge, for example adsorber cartuses or adsorption catalyst, for example cylinder shaped; first embodiment cf. FIGS. 2, 3, 6, 7, 12, 13, 16, 17, 22, 24, 25, 26, 29, 30, 31, 33, 34, 35, 36
20d further fourth filter cartridge, for example adsorber cartuses or adsorption catalyst, for example cylinder shaped; first embodiment cf. FIGS. 2, 3, 6, 7, 12, 13, 16, 17, 22, 24, 25, 26, 29, 30, 31, 33, 34, 35, 36
20a′ filter cartridge, for example adsorber cartuses or adsorption catalyst, for example cylinder shaped; second embodiment cf. FIGS. 12, 13, 16 and 17
20b′ further second filter cartridge, for example adsorber cartuses or adsorption catalyst, for example cylinder shaped; second embodiment cf. FIGS. 12, 13, 16 and 17
20c′ further third filter cartridge, for example adsorber cartuses or adsorption catalyst, for example cylinder shaped; second embodiment cf. FIGS. 12, 13, 16, 17
20d′ further fourth filter cartridge, for example adsorber cartuses or adsorption catalyst, for example cylinder shaped; second embodiment cf. FIGS. 12, 13, 16 and 17
22 counter mounting means of the open end cap 28 of the filter cartridge 20a, 20b, 20c, 20d; 20a′, 20b′, 20c′, 20d′, for example at least one counter snap connection means, such as an engagement groove or rip for forming a snap connection together with a snap-on means 14
24 further counter mounting means of the filter cartridge 20a, 20b, 20c, 20d; 20a′, 20b′, 20c′, 20d′ or of the adapter element 40, 40′, 40″, 40″, for example at least one counter bayonet fastening means, such as a projection, protrusion or nose-piece which is inserted into the transverse slot of the bayonet fastening element 16 and then arranged in the closed position by means of a plug-in rotary movement and causes the fixed-connection to be made; cf. FIGS. 10 to 10 and 29 to 38;
24 further counter mounting means of the filter cartridge 20a, 20b, 20c, 20d; 20a′, 20b′, 20c′, 20d′, 20d′ or of the adapter element 40, 40′, 40″, 40″, for example at least one counter form-fit connection element, such as a horizontal recess, for forming a form-fit connection or form-lock connection with a form-fit connection element 16′ assigned to the base plate 10
25 locking recess or undercut of the adapter element 40′, 40″ (cf. FIGS. 11 and 20)
26 closed end cap or upper end plate of the filter cartridge 20a, 20b, 20c, 20d; 20a′, 20b′, 20c′, 20d′
27 handle for axial movement of the filter cartridge 20a″, 20b″, 20c″, 20d″; first embodiment cf. FIGS. 31 and 36
27′ handle for axial movement of the filter cartridge 20a, 20b, 20c, 20d; 20a′, 20b′, 20c′, 20d′ second embodiment cf. FIGS. 3, 13, 22
28 open end cap or lower end plate or open-end disc of the filter cartridge 20a, 20b, 20c, 20d; 20a′, 20b′, 20c′, 20d′ first embodiment (cf. FIG. 20)
28′ open end cap or lower end plate or open-end disc of the filter cartridge 20a, 20b, 20c, 20d; 20a′, 20b′, 20c′, 20d′; second embodiment (cf. FIG. 29)
29 locking means that prevents the bayonet connection (16, 24) to be accidentally loosened or rotated back cf. FIGS. 32 and 37
30 radial sealing means for sealing the respective filter cartridge 20a, 20b, 20c, 20d; 20a′, 20b′, 20c′, 20d′ with respect to the adapter element 40, 40′, 40″ or with respect to the base plate 10; first embodiment (cf. FIG. 20)
30 radial sealing means for sealing the respective filter cartridge 20a, 20b, 20c, 20d; 20a′, 20b′, 20c′, 20d′ with respect to the adapter element 40, 40′, 40″ or with respect to the base plate 10; second embodiment (cf. FIG. 29)
30″ radial sealing means for sealing the respective filter cartridge 20a, 20b, 20c, 20d; 20a′, 20b′, 20c′, 20d′; with respect to the adapter element 40, 40′, 40″ or with respect to the base plate 10, for example O-ring or quad ring; third embodiment (cf. FIGS. 47 and 55)
32 axial sealing means for sealing the respective filter cartridge 20a, 20b, 20c, 20d; 20a′, 20b′, 20c′, 20d′ with respect to the base plate 10 (cf. FIGS. 29 and 34)
32 circular or quadrangular axial sealing means, for example O-ring or quad ring, second embodiment (cf. FIG. 47)
32″ cylindrical or axial sealing means
40 adapter element or adapter piece of the air filter device 100; first embodiment cf. FIGS. 1, 2, 3, 5, 8 and 9
40 adapter element or adapter piece of the air filter device 100′; second embodiment cf. FIGS. 11, 18 and 19
40″ adapter element or adapter piece of the air filter device 100″; third embodiment cf. FIGS. 20, 27, 28
40″″ adapter element or adapter piece of the air filter device 100″; fourth embodiment cf. FIGS. 29, 34, 37 and 38
40″″ adapter element or adapter piece of the air filter device 100″″; fifth embodiment cf. FIGS. 39 to 46
40″ adapter element or adapter piece of the air filter device 100″″; 1 sixth embodiment cf. FIGS. 47 to 54
40″ adapter element or adapter piece of the air filter device 100″; seventh embodiment cf. FIGS. 55 to 60 adapter element or adapter piece; eighth embodiment cf. FIGS. 61 to 63
40″″ adapter element or adapter piece; ninth embodiment cf. FIGS. 64 to 66
42 snap connection collar of the adapter element 40, 40′, 40″, 40″, 40″, 40″, 40″ the snap connection collar being formed at least partly circumferential, for example radial peripheral edge, such as tubular nozzle segment or tubular socket element, of the adapter element 40, 40′, 40″, 40″, 40″″, 40″″″
44 flattened or thinner-walled circumferential position of the adapter element 40, 40′, 40″
46 rib of the adapter element
47 axial ramp of adapter element 40″
47 radial ramp of adapter element 40″″″″″″
48 ramp partner in the form of a second ramp on connection interface 52 corresponding to axial ramp 47
49 stop rib of radial ramp 47′
50 filter medium body
52 connection interface of the open end cap 28 comprising the counter mounting means 22
54 rib of the connection interface 52 of the open end cap 28
56 sealing interface of the open end cap 28 designed for being in contact with the radial sealing means 30
100 air filter device, for example for air filtration in buildings; first embodiment cf. FIGS. 1 to 10
100′ air filter device, for example for air filtration in buildings; second embodiment cf. FIGS. 11 to 19
100″ air filter device, for example for air filtration in buildings; third embodiment cf. FIGS. 20 to 28
100′″ air filter device, for example for air filtration in buildings; fourth embodiment cf. FIGS. 29 to 38
100″ air filter device, for example for air filtration in buildings; fifth embodiment cf. FIGS. 39 to 46
100′″ air filter device, for example for air filtration in buildings; sixth embodiment cf. FIGS. 47 to 54
100″ air filter device, for example for air filtration in buildings; seventh embodiment cf. FIGS. 55 to 60
200 filter housing for the air filter device 100, 100′, 100″

That which is claimed is:

1. An air filter device for building air filtration, comprising
a base plate with a plurality of spaced-apart flow openings and
a plurality of cylindrical filter cartridges, each having a filter medium body comprising at least one gas filter medium,
wherein the base plate comprises adjacent to the flow openings in each case at least one mounting device for mounting one filter cartridge each on the base plate,
wherein the filter cartridges each have at least one counter mounting means corresponding to the mounting device, which counter mounting means is brought into operative connection with the respective mounting device of the base plate,
wherein the filter cartridges are each sealed directly or indirectly with respect to an edge of the base plate surrounding one of the flow openings,
wherein the base plate is mounted in a filter housing in such a way that it is arranged between an upstream unfiltered air side and a downstream filtered air side,
wherein the mounting device or at least one of the mounting devices of the base plate is designed as a snap connection means, the snap connection means comprising at least one radially deformable, snap-on means and the corresponding counter mounting means or at least one of the corresponding counter mounting means of at least one of the filter cartridges is designed as a counter snap connection means, the counter snap connection means comprising at least one engagement groove being engageable with the snap-on means, wherein the engagement groove is circumferentially formed and/or open radially outward,
wherein the snap connection means and the counter snap connection means form together a snap connection and
wherein the counter snap connection means of the filter cartridge are brought into operative connection with the snap connection means of the base plate by means of an axial movement.

2. The air filter device according to claim 1, wherein the filter cartridges each comprise a closed end cap at one axial end and an open end cap at the other axial end, wherein the open end cap comprises at least one inlet-opening being arranged in the area of at least one of the flow openings to provide an inflow of gas to be filtered into the respective filter cartridge assigned to the open end cap, wherein the counter snap connection means is arranged at the open end cap, and wherein the end caps border the filter medium body terminally.

3. The air filter device according to claim 1, further comprising
at least one further mounting device assigned to the base plate and arranged adjacent to the flow openings and
at least one corresponding further counter mounting means which is brought into operative connection with the further mounting device of the base plate.

4. The air filter device according to claim 2, wherein the snap connection means is arranged on an at least partly circumferential socket section, the socket section being undetachably connected to the base plate or formed integrally with the base plate, such that the snap connection means is arranged on the circumference of a tubular socket section.

5. The air filter device according to claim 3, wherein the base plate comprises at least one adapter element comprising the snap connection means for fastening at least one of the filter cartridges with the adapter element and the further counter mounting means for fastening the adapter element with the base plate, wherein the further counter mounting means
is designed as a counter bayonet fastening means for fastening the adapter element with the base plate by means of a bayonet connection or
is designed as at least one counter form-fit connection means for fastening the adapter element with the base plate by means of a form-fit connection or form-lock connection.

6. The air filter device according to claim 5, wherein
the adapter element comprises at least two or at least three counter bayonet fastening means, at least two or at least three locking protrusions, the respective locking protrusions comprising at least one shaft, such as at least one tubular or cone-shaped shaft, and at least one hat, such as at least one flat or globular or cone-shaped hat, and
the base plate comprises at least two or at least three further mounting devices in the form of engagement recesses, corresponding to the counter bayonet fastening means of the adapter element.

7. The air filter device according to claim 5 wherein the counter form-fit connection means of the adapter element is designed as at least one snapping collar configured to extend through at least one of the flow openings and being formed at least partly circumferential, and wherein the snapping collar is fitted with a locking recess that is to interlock with the further mounting device, with an edge of the base plate surrounding an opening of the base plate to form the form-fit connection.

8. The air filter device according to claim 5, wherein the adapter element is axially sealed with respect to the base plate by means of at least one sealing means or adhesive being axially arranged between the adapter element and the base plate.

9. The air filter device according to claim 5, wherein the adapter element comprises at least one axially extending snap connection collar being formed at least partly circumferential, wherein the snap connection means is arranged at the snap connection collar, and wherein at least two snap connection means are distributed over the circumference of the snap connection collar.

10. The air filter device according to claim 9, wherein the socket section of the base plate and/or the snap connection collar of the adapter element comprises in the area of the snap connection means ribs operable for reinforcing the retention force for mounting the filter cartridge to the base plate.

11. The air filter device according to claim 9, wherein the outer diameter of the snap connection collar comprising the snap connection means for fastening at least one of the filter cartridges with the adapter element and/or a radial peripheral edge of the adapter element facing to the base plate and comprising the further counter mounting means for fastening the adapter element with the base plate, is circular.

12. The air filter device according to claim 1, wherein a face of the base plate, or a face of the adapter element facing the filter cartridge, comprises at least one axial ramp configured for reducing the retention force for demounting the filter cartridge from the base plate or the adapter element, respectively, and the filter cartridge comprises corresponding ramp partner(s) to engage the at least one axial ramp.

13. The air filter device according to claim 1, wherein a radial face of the filter cartridge comprises at least one radial ramp designed to interact with the snap connection means for reducing the retention force for demounting the filter cartridge from the base plate or the adapter element, and wherein the at least one radial ramp comprises a stop rib at the top of the radial ramp.

14. The air filter device according to claim 1, wherein the filter cartridges are each radially sealed with respect to the base plate by means of at least one radial sealing means, the radial sealing means being arranged between a radial peripheral edge of the open end cap of the filter cartridge and a radial peripheral edge of the base plate or of the snap connection collar of the adapter element.

15. The air filter device according to claim 3, wherein
the further counter mounting means is configured as a counter bayonet fastening means for fastening the adapter element with the base plate by means of a bayonet connection and
the adapter element comprises adjacent to the counter bayonet fastening means at least one locking means being operable for cooperating with the bayonet fastening means of the base plate to prevent the bayonet connection to be accidentally loosened or rotated back.

16. The air filter device according to claim 2, wherein the closed end cap comprises at least one handle for applying tensile or compressive force on the filter cartridge to provide the axial movement.

17. An air filter cartridge for an air filter device according to claim 1, wherein the filter cartridge comprises
a filter medium body comprising at least one gas filter medium,
a closed end cap at one axial end of the filter medium body and an open end cap at the other axial end of the filter medium body, wherein the open end cap comprises at least one inlet-opening for the inflow of gas to be filtered into the filter cartridge, wherein the closed end cap and the open end cap border the filter medium body terminally, and
at least one counter snap connection means, which may be brought into operative connection with at least one corresponding snap connection means of the base plate or of the adapter element of the air filter device by means of an axial movement, the counter snap connection means being arranged on at least one circumferential position of the open end cap.

18. The air filter cartridge according claim 17, wherein the counter snap connection means is arranged at a connection interface of the open end cap, wherein the connection interface has a smaller diameter than the filter medium body of the filter cartridges.

19. An adapter element for an air filter device according to claim 4, wherein the adapter element allows a connection of a filter cartridge with the base plate of the air filter device, wherein for mounting the filter cartridge on the base plate the adapter element comprises
at least one mounting device being designed as a snap connection means for forming a snap connection together with a corresponding counter mounting means of at least one of the filter cartridges, and
at least one further counter mounting means in the form of at least one counter bayonet fastening means or at least one counter form-fit connection means, for fastening the adapter element with the base plate.

20. A method for replacing a filter cartridge of an air filter device according to claim 1, wherein
a first filter cartridge is disassembled from the base plate by loosening a snap connection formed between a snap connection means of a base plate and a counter snap connection means of the filter cartridge by means of an axial movement of plus or minus a deviation of 10 degrees from the longitudinal axis of the filter cartridge and
a second filter cartridge is mounted on the base plate by bringing the counter snap connection means of the filter cartridge into operative connection with the snap connection means of the base plate by means of an axial movement.
